(19) United States
(12) Patent Application Publication
(10) Pub. No.: US 2023/0172247 A1
(43) Pub. Date: Jun. 8, 2023

(54) METHOD FOR PRODUCING COMPOSITION FOR FOOD

(71) Applicant: J-OIL MILLS, INC., Tokyo (JP)

(72) Inventors: Ayu MARUI, Tokyo (JP); Keiko YAMAKU, Tokyo (JP); Junpei KUBOTA, Tokyo (JP); Shunsuke MATSUMOTO, Tokyo (JP)

(21) Appl. No.: 17/926,017

(22) PCT Filed: Jun. 3, 2021
(86) PCT No.: PCT/JP2021/021160

§ 371 Date: Nov. 17, 2022

(30) Foreign Application Priority Data
Jun. 3, 2020 (JP) 2020-097232
Nov. 18, 2020 (JP) 2020-192077
Jan. 28, 2021 (JP) 2021-012471

(51) Int. Cl. A23L 33/115; A23L 33/125; A23L 33/19; A23L 33/185

(52) U.S. Cl. CPC A23L 33/115; A23L 33/125; A23L 33/19; A23L 33/185; A23V 2002/00

(57) ABSTRACT

A method for producing a composition for food including: one kind or two kinds selected from the group consisting of a component (A): component (A1): a specific powdery granular material and component (A2): pregelatinized starch; water; edible oil and fat; and an emulsifying material, the method including a step of obtaining an emulsion by mixing the component (A), the water, the edible oil and fat, and the emulsifying material, in which the emulsifying material is at least one kind selected from the group consisting of an emulsifier, a protein, and an oil and fat-processed starch, a content of oil and fat in the emulsion is equal to or more than 0.1 and equal to or less than 120 in terms of mass ratio with respect to the component (A), and a total amount of the component (A), the water, the edible oil and fat, and the emulsifying material in the emulsion is equal to or more than 50% by mass and equal to or less than 100% by mass with respect to the entirety of the emulsion.

### TECHNICAL FIELD

The present invention relates to a method for producing a composition for food.

### BACKGROUND ART

In the production of foods, as typified by bakery foods and processed meat foods, it has been widely practiced to mix raw ingredients to prepare dough, and subsequently a cooking step such as cooking by heating is appropriately performed.

For example, in Patent Document 1 (Japanese Unexamined Patent Publication No. H08-9871), it is described that a hamburg steak is produced by blending minced meat, lard, roasted onion, bread crumbs, starch, spices, water, and soybean protein or a specific starch material (Example 3).

### RELATED DOCUMENT

### Patent Document

[Patent Document 1] Japanese Unexamined Patent Publication No. H08-9871

### SUMMARY OF THE INVENTION

### Technical Problem

The present invention provides a novel production technology for obtaining a food having a preferable texture with satisfactory workability.

### Solution to Problem

According to the present invention, there are provided a method for producing a composition for food, a method for producing a food, a method for enhancing workability when producing a dough for a bakery food, a method for enhancing a texture of a meat processed food or a meat-like processed food, a method for producing a pasty and creamy food, and a method for enhancing a texture of a food after storage, in the following.

[1] A method for producing a composition for food including a component (A), water, edible oil and fat, and an emulsifying material, the method including:

a step of obtaining an emulsion by mixing the component (A), the water, the edible oil and fat, and the emulsifying material,

in which the emulsifying material is at least one kind selected from the group consisting of an emulsifier, a protein, and an oil and fat-processed starch,

a content of oil and fat in the emulsion is equal to or more than 0.1 and equal to or less than 120 in terms of mass ratio with respect to the component (A), and

a total amount of the component (A), the water, the edible oil and fat, and the emulsifying material in the emulsion is equal to or more than 50% by mass and equal to or less than 100% by mass with respect to the entirety of the emulsion,

component (A): one kind or two kinds selected from the group consisting of component (A1) and component (A2):

component (A1): a powdery granular material satisfying the following conditions (1) to (4):

(1) a starch content is equal to or more than 75% by mass,

(2) a low molecular weight starch obtained from a starch having an amylose content of equal to or more than 5% by mass is included, a content of the low molecular weight starch being equal to or more than 3% by mass and equal to or less than 45% by mass, and the low molecular weight starch has a peak molecular weight of equal to or more than 3×10³ and equal to or less than 5×10⁴,

(3) a degree of swelling in cold water at 25° C. is equal to or higher than 5 and equal to or lower than 20, and

(4) a content of a fraction passing through a sieve with a mesh size of 3.35 mm and remaining on a sieve with a mesh size of 0.038 mm is equal to or more than 60% by mass and equal to or less than 100% by mass; and

component (A2): pregelatinized starch.

[2] The method for producing a composition for food according to [1], in which a total content of moisture in the emulsion is more than 2 in terms of mass ratio with respect to the component (A).

[3] The method for producing a composition for food according to [1] or [2],

in which the edible oil and fat is one kind or two or more kinds selected from the group consisting of rapeseed oil, olive oil, lard, and milk fat.

[4] The method for producing a composition for food according to [1] or [2],

in which the edible oil and fat is one kind or two or more kinds selected from the group consisting of rapeseed oil, olive oil, lard, milk fat, and soybean oil.

[5] The method for producing a composition for food according to any one of [1] to [4],

in which the protein is one kind or two or more kinds selected from the group consisting of soybean protein, pea protein, milk protein, and egg protein.

[6] The method for producing a composition for food according to any one of [1] to [5],

in which the emulsifying material or a formulation component including the emulsifying material is one kind or two or more kinds selected from the group consisting of soybean milk, milk, fresh cream, skim milk powder, whole milk powder, casein, egg yolk, egg white, and whole egg.

[7] The method for producing a composition for food according to any one of [1] to [6],

in which the step of obtaining an emulsion is a step of obtaining the emulsion, in which a heating yield of a dough obtained by heating the emulsion at 200° C. for 5 minutes is equal to or greater than 85% by mass and equal to or less than 100% by mass.

[8] The method for producing a composition for food according to any one of [1] to [7],

in which a solid fat content at 20° C. of the edible oil and fat is equal to or less than 40%.

[9] The method for producing a composition for food according to any one of [1] to [8],

further including, after the step of obtaining an emulsion, a step of performing a pressurized heating treatment.

[10] The method for producing a composition for food according to any one of [1] to [8],

further including, after the step of obtaining an emulsion, one kind or two kinds of steps selected from the group consisting of frozen storage and refrigerated storage.

[11] A method for producing a food, the method including:

a step of obtaining a composition for food by the method for producing a composition for food according to anyone of [1] to [10]; and

a step of obtaining a food by preparing ingredients including the composition for food.

[12] The method for producing a food according to [11],

in which the step of obtaining a food includes cooking by heating.

[13] A method for enhancing workability when mixing raw materials including component (A), water, edible oil and fat, and an emulsifying material to produce a dough for a bakery food, the method including:

a step of obtaining an emulsion by mixing the component (A), the water, the edible oil and fat, and the emulsifying material,

in which the emulsifying material is at least one kind selected from the group consisting of an emulsifier, a protein, and an oil and fat-processed starch,

a content of oil and fat in the emulsion is equal to or more than 0.1 and equal to or less than 120 in terms of mass ratio with respect to the component (A), and

a total amount of the component (A), the water, the edible oil and fat, and the emulsifying material in the emulsion is equal to or more than 50% by mass and equal to or less than 100% by mass with respect to the entirety of the emulsion,

component (A): one kind or two kinds selected from the group consisting of component (A1) and component (A2):

component (A1): a powdery granular material satisfying the following conditions (1) to (4):

(1) a starch content is equal to or more than 75% by mass,

(2) a low molecular weight starch obtained from a starch having an amylose content of equal to or more than 5% by mass is included, a content of the low molecular weight starch being equal to or more than 3% by mass and equal to or less than 45% by mass, and the low molecular weight starch has a peak molecular weight of equal to or more than 3×10³ and equal to or less than 5×10⁴,

(3) a degree of swelling in cold water at 25° C. is equal to or higher than 5 and equal to or lower than 20, and

(4) a content of a fraction passing through a sieve with a mesh size of 3.35 mm and remaining on a sieve with a mesh size of 0.038 mm is equal to or more than 60% by mass and equal to or less than 100% by mass; and

component (A2): pregelatinized starch.

[14] A method for enhancing a texture of a meat processed food or a meat-like processed food, both including raw materials including component (A), water, edible oil and fat, and an emulsifying material, the method including:

a step of obtaining an emulsion by mixing the component (A), the water, the edible oil and fat, and the emulsifying material,

in which the emulsifying material is at least one kind selected from the group consisting of an emulsifier, a protein, and an oil and fat-processed starch,

a content of oil and fat in the emulsion is equal to or more than 0.1 and equal to or less than 120 in terms of mass ratio with respect to the component (A), and

a total amount of the component (A), the water, the edible oil and fat, and the emulsifying material in the emulsion is equal to or more than 50% by mass and equal to or less than 100% by mass with respect to the entirety of the emulsion,

component (A): one kind or two kinds selected from the group consisting of component (A1) and component (A2):

component (A1): a powdery granular material satisfying the following conditions (1) to (4):

(1) a starch content is equal to or more than 75% by mass,

(2) a low molecular weight starch obtained from a starch having an amylose content of equal to or more than 5% by mass is included, a content of the low molecular weight starch being equal to or more than 3% by mass and equal to or less than 45% by mass, and the low molecular weight starch has a peak molecular weight of equal to or more than 3×10³ and equal to or less than 5×10⁴,

(3) a degree of swelling in cold water at 25° C. is equal to or higher than 5 and equal to or lower than 20, and

(4) a content of a fraction passing through a sieve with a mesh size of 3.35 mm and remaining on a sieve with a mesh size of 0.038 mm is equal to or more than 60% by mass and equal to or less than 100% by mass; and

component (A2): pregelatinized starch.

A method for enhancing a texture after storage of a food including raw materials including component (A), water, edible oil and fat, and an emulsifying material,

a step of obtaining an emulsion by mixing the component (A), the water, the edible oil and fat, and the emulsifying material,

in which the emulsifying material is at least one kind selected from the group consisting of an emulsifier, a protein, and an oil and fat-processed starch,

a content of oil and fat in the emulsion is equal to or more than 0.1 and equal to or less than 120 in terms of mass ratio with respect to the component (A), and

a total amount of the component (A), the water, the edible oil and fat, and the emulsifying material in the emulsion is equal to or more than 50% by mass and equal to or less than 100% by mass with respect to the entirety of the emulsion,

component (A): one kind or two kinds selected from the group consisting of component (A1) and component (A2):

component (A1): a powdery granular material satisfying the following conditions (1) to (4):

(1) a starch content is equal to or more than 75% by mass,

(2) a low molecular weight starch obtained from a starch having an amylose content of equal to or more than 5% by mass is included, a content of the low molecular weight starch being equal to or more than 3% by mass and equal to or less than 45% by mass, and the low molecular weight starch has a peak molecular weight of equal to or more than 3×10³ and equal to or less than 5×10⁴,

(3) a degree of swelling in cold water at 25° C. is equal to or higher than 5 and equal to or lower than 20, and

(4) a content of a fraction passing through a sieve with a mesh size of 3.35 mm and remaining on a sieve with a mesh size of 0.038 mm is equal to or more than 60% by mass and equal to or less than 100% by mass; and

component (A2): pregelatinized starch.

### Advantageous Effects of Invention

According to the present invention, a novel production technology for obtaining a food having a preferable texture with satisfactory workability can be provided.

### BRIEF DESCRIPTION OF THE DRAWINGS

FIG. 1 is a diagram showing the results of texture analyzer measurement of kamaboko (boiled fish-paste)-like foods.

FIG. 2 is a diagram showing the results of texture analyzer measurement of kamaboko-like foods.

FIG. 3 is a diagram showing the results of texture analyzer measurement of kamaboko-like foods.

FIG. 4 is a diagram showing the results of texture analyzer measurement of kamaboko-like foods.

### DESCRIPTION OF EMBODIMENTS

Hereinafter, embodiments of the present invention will be described. Unless particularly stated otherwise, the term “to” in a numerical range indicates being equal to or more than a value and equal to or less than another value, both the values at the two ends being included. Furthermore, in the present embodiment, a composition can include each component singly or in combination of two or more kinds thereof.

(Method for Producing Composition for Food)

According to the present embodiment, a method for producing a composition for food is a method for producing a composition for food including component (A), water, edible oil and fat, and an emulsifying material, the method including a step of obtaining an emulsion by mixing component (A), water, edible oil and fat, and an emulsifying material.

Component (A) is one kind or two kinds selected from the group consisting of the following component (A1) and component (A2).

component (A1): a powdery granular material satisfying the following conditions (1) to (4):

(1) a starch content is equal to or more than 75% by mass,

(2) a low molecular weight starch obtained from a starch having an amylose content of equal to or more than 5% by mass is included, a content of the low molecular weight starch being equal to or more than 3% by mass and equal to or less than 45% by mass, and the low molecular weight starch has a peak molecular weight of equal to or more than 3×10³ and equal to or less than 5×10⁴,

(3) a degree of swelling in cold water at 25° C. is equal to or higher than 5 and equal to or lower than 20, and

(4) a content of a fraction passing through a sieve with a mesh size of 3.35 mm and remaining on a sieve with a mesh size of 0.038 mm is equal to or more than 60% by mass and equal to or less than 100% by mass; and

component (A2): pregelatinized starch.

The emulsifying material is at least one kind selected from the group consisting of an emulsifier, a protein, and an oil and fat-processed starch.

A content of oil and fat in the emulsion is equal to or more than 0.1 and equal to or less than 120 in terms of mass ratio with respect to the component (A). Furthermore, a total amount of the component (A), water, the edible oil and fat, and the emulsifying material in the emulsion is equal to or more than 50% by mass and equal to or less than 100% by mass with respect to the entirety of the emulsion.

According to the present embodiment, the method for producing a composition for food includes a step of obtaining an emulsion including specific components at specific proportions. By obtaining a composition for food by such a production method and using the composition in a food, a food having a preferable texture can be obtained with satisfactory workability. Furthermore, according to the present embodiment, for example, a food having an excellent texture after storage can be obtained.

The mixing method in the step of obtaining an emulsion can be selected, for example, according to the type of food to which the composition for food is applied, and the characteristics of the emulsifying material.

Specifically, when the emulsifying material is a powder, the component (A) and the emulsifying material are uniformly suspended in the edible oil and fat, water is added thereto, and the mixture is mixed. When the mixing apparatus at this time is a Kenmix Mixer, the mixture is mixed at a stirring speed with intensity 1 to 3 for 1 to 15 minutes, and preferably at a stirring speed with intensity 1 to 3 for 3 minutes to 10 minutes. When the mixing apparatus is a tabletop cutter mixer, the mixture can be prepared in 15 to 60 seconds.

When the emulsifying material is a liquid, the mixture can be prepared by dispersing the component (A) in the edible oil and fat, adding the emulsifying material and water thereto in this order, and mixing the components in the same manner as described above.

However, since the optimum emulsification conditions vary even depending on the stirring speed, the shape of the stirring blade, the shape of the stirring container, and the charge-in weight of each raw material, the method is not limited to the above-described method.

Hereinafter, each component used in the production of the composition for food will be described.

(Component (A))

Component (A) is one kind or two kinds selected from the group consisting of the above-mentioned component (A1) and component (A2).

Among these, component (A1) is a powdery granular material that satisfies conditions (1) to (4).

With regard to condition (1), from the viewpoint of enhancing workability at the time of handling the composition for food, the component (A1) includes equal to or more than 75% by mass of starch with respect to the entirety of the component (A1) and preferably includes equal to or more than 80% by mass, and more preferably equal to or more than 85% by mass, of starch.

Furthermore, there is no limit on the upper limit of the content of starch in the component (A1), and the upper limit is equal to or less than 100% by mass with respect to the entirety of the component (A1); however, depending on the characteristics of the composition for food, the upper limit may also be equal to or less than 99.5% by mass, equal to or less than 99% by mass, or the like.

With regard to the component (A1), the starch is, for example, starch for foods, and various-derived starches can be used. For example, as the starch, one or more kinds can be appropriately selected from starches such as cornstarch, potato starch, tapioca starch, wheat starch, rice starch, and bean starch (for example, pea starch); and processed starches obtained by chemically, physically, or enzymatically processing these starches. From the viewpoint of enhancing workability at the time of handling the composition for food, the starch is preferably one kind or two or more kinds selected from tapioca starch, cornstarch, rice starch, and bean starch, and more preferably one kind or two kinds selected from tapioca starch and cornstarch.

From a similar viewpoint, the raw material from which the starch is derived is preferably one kind or two or more kinds selected from the group consisting of cassava, corn, rice, and beans.

With regard to condition (2), the component (A1) specifically includes a low molecular weight starch and another starch. First, the low molecular weight starch will be described.

From the viewpoint of enhancing workability at the time of handling the composition for food, the amylose content in a raw material starch for the low molecular weight starch is equal to or more than 5% by mass, preferably equal to or more than 12% by mass, more preferably equal to or more than 22% by mass, even more preferably equal to or more than 40% by mass, still more preferably equal to or more than 45% by mass, even more preferably equal to or more than 55% by mass, and still more preferably equal to or more than 65% by mass. The upper limit of the amylose content in the raw material starch for the low molecular weight starch is not limited, and the upper limit is equal to or less than 100% by mass, preferably equal to or less than 90% by mass, and more preferably equal to or less than 80% by mass.

As a starch having an amylose content of equal to or more than 5% by mass, which is a raw material for the low molecular weight starch, any one kind or two or more kinds selected from the group consisting of cornstarch such as high-amylose cornstarch and cornstarch, tapioca starch, sweet potato starch, potato starch, wheat starch, high-amylose wheat starch, rice starch, bean starch (for example, pea starch), and processed starches obtained by chemically, physically, or enzymatically processing these raw materials, can be used. From the viewpoint of enhancing workability at the time of handling the composition for food, the starch having an amylose content of equal to or more than 5% by mass is one kind or two or more kinds selected from high-amylose cornstarch, cornstarch, tapioca starch, and bean starch, and more preferably high-amylose cornstarch. As the high-amylose cornstarch, for example, one having an amylose content of equal to or more than 40% by mass is available. The starch having an amylose content of equal to or more than 5% by mass is more preferably a cornstarch having an amylose content of equal to or more than 40% by mass.

The content of the low molecular weight starch in the component (A1) is equal to or more than 3% by mass, preferably equal to or more than 8% by mass, and more preferably equal to or more than 13% by mass, from the viewpoint of enhancing workability at the time of handling the composition for food.

From a similar viewpoint, the content of the low molecular weight starch in the component (A1) is equal to or less than 45% by mass, preferably equal to or less than 35% by mass, and more preferably equal to or less than 25% by mass.

The peak molecular weight of the low molecular weight starch is equal to or more than 3×10³, and preferably equal to or more than 8×10³, from the viewpoint of enhancing workability at the time of handling the composition for food.

From a similar viewpoint, the peak molecular weight of the low molecular weight starch is equal to or less than 5×10⁴, preferably equal to or less than 3×10⁴, and more preferably equal to or less than 1.5×10⁴. The method for measuring the peak molecular weight of a low molecular weight starch will be described in the section of Examples.

Here, from the viewpoint of having excellent production stability, the low molecular weight starch is preferably one kind or two or more kinds selected from the group consisting of an acid-treated starch, an oxidation-treated starch, and an enzyme-treated starch, and the low molecular weight starch is more preferably an acid-treated starch.

The conditions of an acid treatment for obtaining an acid-treated starch are not limited; however, for example, the starch can be treated as follows.

First, a starch having an amylose content of equal to or more than 5% by mass, which is a raw material, and water are introduced into a reactor, and an acid is further introduced. Alternatively, acid water obtained by dissolving an inorganic acid in advance in water and the starch as a raw material are introduced into a reactor. From the viewpoint of performing the acid treatment more stably, it is desirable that the total amount of starch in the reaction is in a state of being homogeneously dispersed in an aqueous phase, or in a slurrified state. For that purpose, the concentration of the starch slurry for performing the acid treatment is adjusted to be in the range of, for example, equal to or more than 10% by mass and equal to or less than 50% by mass, and preferably equal to or more than 20% by mass and equal to or less than 40% by mass. When the slurry concentration is too high, the slurry viscosity may increase, and uniform stirring of the slurry may be difficult.

Specific examples of the acid to be used for the acid treatment include inorganic acids such as hydrochloric acid, sulfuric acid, and nitric acid, which can be utilized regardless of the type, purity, and the like.

With regard to the acid treatment reaction conditions, for example, the inorganic acid concentration at the time of the acid treatment is preferably equal to or greater than 0.05 normality (N) and equal to or less than 4 N, more preferably equal to or greater than 0.1 N and equal to or less than 4 N, and even more preferably equal to or greater than 0.2 N and equal to or less than 3 N, from the viewpoint of stably obtaining the acid-treated starch. From a similar viewpoint, the reaction temperature is preferably equal to or higher than 30° C. and equal to or lower than 70° C., more preferably equal to or higher than 35° C. and equal to or lower than 70° C., and even more preferably equal to or higher than 35° C. and equal to or lower than 65° C., and from a similar viewpoint, the reaction time is preferably equal to or more than 0.5 hours and equal to or less than 120 hours, more preferably equal to or more than 1 hour and equal to or less than 72 hours, and even more preferably equal to or more than 1 hour and equal to or less than 48 hours.

Regarding the starch other than the low molecular weight starch in the component (A1), for example, the starch can be selected from the above-mentioned starches and used. Preferably, the starch other than the low molecular weight starch in the component (A1) is one kind or two or more kinds selected from the group consisting of cornstarch, wheat starch, potato starch, tapioca starch, and cross-linked starches thereof.

With regard to condition (3), from the viewpoint of enhancing workability at the time of handling the composition for food, the degree of swelling in cold water of the component (A1) is equal to or higher than 5, preferably equal to or higher than 6, and more preferably equal to or higher than 6.5.

From a similar viewpoint, the degree of swelling in cold water of the component (A1) is equal to or lower than 20, preferably equal to or lower than 17, more preferably equal to or lower than 13, and even more preferably equal to or lower than 12.

Here, the method for measuring the degree of swelling in cold water of the component (A1) will be described in the section of Examples.

With regard to condition (4), the content of a fraction passing through a sieve with a mesh size of 3.35 mm and remaining on a sieve with a mesh size of 0.038 mm in the component (A1) is equal to or more than 60% by mass, preferably equal to or more than 70% by mass, more preferably equal to or more than 80% by mass, even more preferably equal to or more than 90% by mass, and still more preferably equal to or more than 95% by mass, with respect to the entirety of the component (A1) from the viewpoint of enhancing workability at the time of handling the composition for food.

From a similar viewpoint, the content of the fraction passing through a sieve with a mesh size of 3.35 mm and remaining on a sieve with a mesh size of 0.038 mm in the component (A1) is equal to or less than 100% by mass with respect to the entirety of the component (A1).

From the viewpoint of enhancing workability at the time of handling the composition for food, and from the viewpoint of enhancing dispersibility when blending the composition for food into a food, the content of a fraction passing through a sieve with a mesh size of 0.5 mm and remaining on a sieve with a mesh size of 0.075 mm in the component (A1) is preferably equal to or more than 20% by mass, more preferably equal to or more than 30% by mass, even more preferably equal to or more than 40% by mass, and still more preferably equal to or more than 50% by mass, and for example, the content is equal to or less than 100% by mass, and preferably equal to or less than 90% by mass.

From the viewpoint of enhancing workability at the time of handling the composition for food, and from the viewpoint of favorability of the texture of a food prepared by using the composition for food, the content of a fraction passing through a sieve with a mesh size of 0.25 mm and remaining on a sieve with a mesh size of 0.038 mm in the component (A1) is preferably equal to or more than 10% by mass, more preferably equal to or more than 20% by mass, even more preferably equal to or more than 30% by mass, still more preferably equal to or more than 40% by mass, and for example, the content is equal to or less than 100% by mass.

Next, component (A2) will be described. Specifically, the component (A2) is pregelatinized starch other than the component (A1). The component (A2) is specifically obtained by subjecting starch to a gelatinization treatment.

As a raw material starch for the pregelatinized starch, one kind or two or more kinds selected from the group consisting of high-amylose cornstarch, cornstarch, tapioca starch, sweet potato starch, potato starch, wheat starch, high-amylose wheat starch, rice starch, and processed starches obtained by chemically, physically, or enzymatically processing these raw materials, can be used. From the viewpoint of enhancing the emulsion stability of the composition for food, it is preferable to use one kind or two or more kinds selected from high-amylose cornstarch, cornstarch, and tapioca starch, and high-amylose cornstarch is more preferable. Here, high-amylose cornstarch is a cornstarch in which an amylose content has been increased by breeding. Regarding the amylose content of the high-amylose cornstarch, cornstarches having an amylose content of equal to or more than 40% by mass are available.

The amylose content of the high-amylose cornstarch is preferably equal to or more than 40% by mass, more preferably equal to or more than 45% by mass, and even more preferably equal to or more than 48% by mass.

Furthermore, there is no limit on the upper limit of the amylose content of the high-amylose cornstarch, and the upper limit is equal to or less than 100% by mass; however, from the viewpoint of enhancing the emulsion stability of the composition for food, the upper limit is preferably equal to or less than 90% by mass, more preferably equal to or less than 80% by mass, even more preferably equal to or less than 75% by mass, still more preferably equal to or less than 70% by mass, and particularly preferably equal to or less than 65% by mass.

Here, examples of the method for the pregelatinization treatment include a jet cooker treatment, a drum dryer treatment, and an extruder treatment.

Furthermore, as an index indicating the degree of pregelatinization of the component (A2), the above-mentioned degree of swelling in cold water can be used.

From the viewpoint of enhancing workability at the time of handling the composition for food, the degree of swelling in cold water at 25° C. of the component (A2) is preferably equal to or higher than 3, more preferably equal to or higher than 4, even more preferably equal to or higher than 4.5, still more preferably equal to or higher than 5, and even more preferably equal to or higher than 5.5, in terms of dry food.

From a similar viewpoint, the degree of swelling in cold water at 25° C. of the component (A2) is preferably equal to or lower than 40, more preferably equal to or lower than 30, even more preferably equal to or lower than 20, still more preferably equal to or lower than 15, and even more preferably equal to or lower than 12, in terms of dry food.

From the viewpoint of enhancing the emulsion stability of the composition for food, the content of the component (A) in the emulsion is preferably equal to or more than 1% by mass, more preferably equal to or more than 2% by mass, even more preferably equal to or more than 5% by mass, and still more preferably equal to or more than 8% by mass, with respect to the entirety of the emulsion.

Furthermore, from a similar viewpoint, the content of the component (A) in the emulsion is preferably equal to or less than 25% by mass, more preferably equal to or less than 20% by mass, even more preferably equal to or less than 15% by mass, and still more preferably equal to or less than 12% by mass, with respect to the entirety of the emulsion.

(Water)

An amount of water that is blended in the step of obtaining the emulsion can be set, for example, as the balance excluding the components other than water in the raw materials of the emulsion.

From the viewpoint of enhancing the emulsion stability of the composition for food, the total content of moisture in the emulsion is preferably more than 2, more preferably equal to or more than 3, and even more preferably equal to or more than 3.5, in terms of mass ratio with respect to the component (A).

From the viewpoint of enhancing the emulsion stability of the composition for food, the total content of the moisture in the emulsion may be, for example, equal to or less than 10, preferably equal to or less than 6, more preferably equal to or less than 5.5, and even more preferably equal to or less than 5, in terms of mass ratio with respect to the component (A).

Here, the total content of the moisture in the emulsion is the amount obtained by adding up the water blended in the step of obtaining the emulsion, and the water included in the components other than powder raw materials (for example, component (A)) among the components included in other formulation components.

(Edible Oil and Fat)

Specific examples of the edible oil and fat include vegetable oils and fats such as soybean oil, rapeseed oil (canola oil), palm oil, corn oil, olive oil (olive oil), sesame oil, safflower oil, sunflower oil, cottonseed oil, rice oil, peanut oil, palm kernel oil, coconut oil, perilla oil, and linseed oil; animal oils and fats such as beef tallow, lard, milk fat, chicken oil, and fish oil; and synthetic oils and fats such as medium-chain fatty acid triglycerides. Furthermore, processed oils and fats obtained by subjecting these oils and fats to fractionation, hydrogenation, transesterification, and the like may be mentioned.

Furthermore, these edible oils and fats may also be products obtained by treating the oils and fats with flavor-imparting agents such as vegetables, or products obtained by flavoring the oils and fats with flavoring agents such as flavors, seasonings, and natural materials. Specific examples thereof include flavored edible oils such as garlic oil and chili oil.

Furthermore, the above-mentioned edible oils and fats may be used as they are or may be used as plastic oils and fats such as margarine, shortening, and butter.

From the viewpoint of enhancing workability at the time of handling the composition for food, the edible oil and fat is preferably one kind or two or more kinds selected from the group consisting of rapeseed oil, soybean oil, olive oil, lard, and milk fat, and more preferably one kind or two or more kinds selected from the group consisting of rapeseed oil, olive oil, lard, and milk fat.

When the composition for food is used in a bakery food, the edible oil and fat is preferably one kind or two or more kinds selected from the group consisting of olive oil, soybean oil and rapeseed oil, from the viewpoint of enhancing workability at the time of handling the composition for food. Furthermore, it is preferable to use one kind or two kinds selected from edible oils and fats as they are and margarine.

When the composition for food is used for a meat processed food or a meat-like processed food, from the viewpoints of flavor compatibility and workability, the edible oil and fat is preferably animal oil and fat, and more preferably one kind or two or more kinds selected from the group consisting of lard, beef tallow, and chicken oil.

When the composition for food is used for a processed sea food, from the viewpoints of flavor compatibility and workability, the edible oil and fat is preferably vegetable oil and fat, and more preferably one kind or two or more kinds selected from the group consisting of rapeseed oil, soybean oil, and olive oil.

A solid fat content of the edible oil and fat at 20° C. is preferably equal to or less than 40%, more preferably equal to or less than 30%, even more preferably equal to or less than 20%, and still more preferably equal to or less than 10%, from the viewpoint of enhancing workability at the time of handling the composition for food. Furthermore, the solid fat content is, for example, equal to or more than 0%.

Here, the solid fat content of the edible oil and fat can be measured by the method of AOCS Official Method Cd 16b-93.

When the edible oil and fat is used as a water-in-oil type oil and fat composition such as margarine or butter, the solid fat content of an oil phase obtained by melting the water-in-oil type oil and fat composition and then separating an aqueous phase therefrom is considered as the solid fat content of the edible oil and fat.

The amount of the edible oil and fat that is blended in the step of obtaining an emulsion can be an amount such that, for example, the content of oils and fats in the emulsion is in the following range. Here, the content of oils and fats in the emulsion is an amount (total amount of oils and fats) obtained by adding up the edible oil and fat to be blended in the step of obtaining an emulsion, and the oils and fats included in other formulation components.

For example, when the composition for food is blended into a dough for a bakery food, a meat processed food, a meat-like processed food, or a processed sea food and used, from the viewpoint of enhancing workability at the time of handling the composition for food, the content of oils and fats in the emulsion is equal to or more than 0.1, preferably equal to or more than 1.5, more preferably equal to or more than 2.0, even more preferably equal to or more than 3.0, still more preferably equal to or more than 3.5, and even more preferably equal to or more than 4.0, in terms of mass ratio with respect to the component (A).

From a similar viewpoint, the content of oils and fats in the emulsion is equal to or less than 120, preferably equal to or less than 9, more preferably equal to or less than 8, even more preferably equal to or less than 7, and still more preferably equal to or less than 6.

For example, when the composition for food is used as a batter liquid, the content of oils and fats in the emulsion is equal to or more than 1, and preferably equal to or more than 2, in terms of mass ratio with respect to the component (A). The content of oils and fats in the emulsion is equal to or less than 120, preferably equal to or less than 9, and more preferably equal to or less than 5.

When used as a pickling liquid, the content of oils and fats in the emulsion is equal to or more than 10, preferably equal to or more than 20, more preferably equal to or more than 30, and even more preferably equal to or more than 35, in terms of mass ratio with respect to the component (A). The content of oils and fats in the emulsion is equal to or less than 120, preferably equal to or less than 110, and more preferably equal to or less than 100.

For example, when the composition for food is used for a creamy or pasty food, the content of oils and fats in the emulsion is equal to or more than 0.1, preferably equal to or more than 0.5, and more preferably equal to or more than 0.9, by mass ratio with respect to the component (A). The content of oils and fats in the emulsion is equal to or less than 120, preferably equal to or less than 110, and more preferably equal to or less than 100.

For example, when the composition for food is used for a snack confectionery, the content of oils and fats in the emulsion is equal to or more than 0.9, preferably equal to or more than 1, and more preferably equal to or more than 2, in terms of mass ratio with respect to the component (A). The content of oils and fats in the emulsion is equal to or less than 120, preferably equal to or less than 9, and more preferably equal to or less than 5.

(Emulsifying Material)

The emulsifying material is specifically at least one kind selected from the group consisting of an emulsifier, a protein, and an oil and fat-processed starch, and more specifically at least one kind selected from the group consisting of a protein and an oil and fat-processed starch.

In the step of obtaining an emulsion, the emulsifying material may be added as these components themselves or may be added in the form of a formulation component (food material) including at least one of these components.

Examples of the protein include a plant protein and an animal protein. Examples of the plant protein include wheat proteins such as gluten; soybean proteins such as soybean milk, tofu, and proteins in defatted soybean powder; and seed proteins such as corn proteins and pea proteins. Examples of the animal protein include egg proteins such as egg white protein and egg yolk protein; milk proteins such as whey protein, casein, and salts thereof (for example, casein Na); blood proteins such as plasma proteins and blood cell proteins; muscle proteins such as meat protein and fish meat protein; gelatin, and collagen.

From the viewpoint of enhancing workability at the time of handling the composition for food, the protein is preferably one kind or two or more kinds selected from the group consisting of soybean proteins, milk proteins, and egg proteins. Furthermore, from the viewpoint of making the state of the dough after heating more preferable, the protein is one kind or two or more kinds selected from the group consisting of soybean proteins, pea proteins, milk proteins, and egg proteins, and more preferably one kind or two or more kinds selected from the group consisting of soybean proteins, milk proteins, and egg proteins.

The oil and fat-processed starch is a kind of starchy material and specifically refers to a starchy material produced through a step including a step of adding an edible oil and fat or an oil or fat-related substance to the raw material starch, the step including an operation of mixing and heating after the above-described step.

Examples of the emulsifier include an alginic acid ester, lecithin, a monoglycerin fatty acid ester, a monoglycerin organic acid fatty acid ester, a polyglycerin fatty acid ester, a polyglycerin condensed ricinoleic acid ester, a sorbitan fatty acid ester, a propylene glycol fatty acid ester, and a sucrose fatty acid ester. The emulsifier is preferably a polyglycerin fatty acid ester.

Furthermore, it is desirable to use a mixture of two or more kinds of emulsifiers having different HLBs, and for example, it is desirable to use an emulsifier having an HLB of 5 to 7 and an emulsifier having an HLB of 14 to 16 in combination. A specific combination of emulsifiers may be, for example, a combination of diglycerin monostearic acid ester and decaglycerin monomyristate.

From the viewpoint of enhancing workability at the time of handling the composition for food, the emulsifying material or the formulation component including an emulsifying material is preferably one kind or two or more kinds selected from the group consisting of soybean milk, tofu, milk, fresh cream, skim milk powder, whole milk powder, casein, whey, concentrated whey, muscle proteins, egg white, dried egg white, and whole egg; more preferably one kind or two or more kinds selected from the group consisting of soybean milk, tofu, milk, fresh cream, skim milk powder, whole milk powder, casein, whey, concentrated whey, muscle proteins, egg white, and whole egg; even more preferably one kind or two or more kinds selected from the group consisting of soybean milk, milk, fresh cream, skim milk powder, whole milk powder, casein, egg yolk, egg white, dried egg white, and whole egg; and still more preferably one kind or two or more kinds selected from the group consisting of soybean milk, milk, fresh cream, skim milk powder, whole milk powder, casein, egg white, and whole egg.

From the viewpoint of enhancing workability at the time of handling the composition for food, the amount of the emulsifying material that is blended in the step of obtaining an emulsion is preferably equal to or more than 0.1% by mass, more preferably equal to or more than 0.3% by mass, even more preferably equal to or more than 2% by mass, still more preferably equal to or more than 3% by mass, even more preferably equal to or more than 5% by mass, and still more preferably equal to or more than 8% by mass, with respect to the entirety of the emulsion.

Furthermore, from the viewpoint of enhancing workability at the time of handling the composition for food, the amount of the emulsifying material that is blended in the step of obtaining an emulsion is preferably equal to or less than 20% by mass, more preferably equal to or less than 15% by mass, and even more preferably equal to or less than 12% by mass, with respect to the entirety of the emulsion.

From the viewpoint of enhancing workability at the time of handling the composition for food, the total amount of the component (A), water, the edible oil and fat, and the emulsifying material in the emulsion is equal to or more than 50% by mass, preferably equal to or more than 60% by mass, more preferably equal to or more than 70% by mass, even more preferably equal to or more than 80% by mass, still more preferably equal to or more than 90% by mass, and for example, equal to or less than 100% by mass, with respect to the entirety of the emulsion.

In the emulsion, components other than the above-mentioned components may also be appropriately blended. Specific examples of such components include one kind or two or more kinds selected from the group consisting of salts, such as magnesium salts such as magnesium chloride and magnesium sulfate, potassium salts such as potassium chloride, and calcium salts such as calcium chloride, calcium carbonate, and calcium sulfate; coagulating agents such as glucono-delta-lactone; and sugars such as lactose.

The step of obtaining an emulsion is a step of obtaining an emulsion, in which the heating yield of a dough obtained by heating the emulsion at 200° C. for 5 minutes is preferably equal to or greater than 85% by mass and equal to or less than 100% by mass.

That is, the heating yield is preferably equal to or greater than 85% by mass, more preferably equal to or greater than 88% by mass, even more preferably equal to or greater than 92% by mass, and for example, equal to or less than 100% by mass.

Returning to the description of the method for producing a composition for food, the emulsion obtained in the step of obtaining an emulsion may have fluidity or may be solid.

When an emulsion having fluidity is obtained, it is also preferable to set the viscosity of the emulsion as follows. That is, the viscosity of the emulsion obtained by the following method is preferably equal to or greater than 2900 cps, more preferably equal to or greater than 3000 cps, and even more preferably equal to or greater than 3500 cps, from the viewpoint of enhancing workability at the time of blending into a food. The upper limit value of the viscosity may be, for example, equal to or less than 100000 cps.

(Method for Measuring Viscosity)

1. An emulsion is produced according to any of the above-mentioned methods.

2. The entire amount of the emulsion obtained in 1. is transferred into a bowl, wrapped, and left to stand at normal temperature of 25° C. for 1 hour.

3. 250 g is weighed in a glass beaker having a volume of 300 mL, and the viscosity is measured by using a B-type viscometer (for example, TOKIMEC INC. B-type viscometer MODEL: BM) under the conditions of a No. 4 rotor, 60 rpm, and 30 seconds.

The method for producing a composition for food may further include steps other than the step of obtaining an emulsion. For example, the method for producing a composition for food may include a step of performing a pressurized heating treatment (for example, a retorting treatment) after the step of obtaining an emulsion, and more specifically, the method may further include a step of performing a pressurized heating treatment at 100° C. to 130° C. and 0.206 MPa for 1 to 60 minutes, after the step of obtaining an emulsion.

Furthermore, the method for producing a composition for food may further include one kind or two kinds of steps selected from the group consisting of frozen storage and refrigerated storage, after the step of obtaining an emulsion.

The storage temperature for freezing can be, for example, equal to or higher than −100° C. and lower than 0° C. The storage temperature for refrigeration can be, for example, equal to or higher than 0° C. and equal to or lower than 15° C.

The composition for food obtained in the present embodiment can be suitably used as, for example, a dough for a bakery food, a meat processed food, a meat-like processed food, a processed sea food, a vegetable processed food, or the like; a dough for snack confectionery; a creamy food or a pasty food; a pickling liquid; or a batter liquid.

(Method for Producing Food)

The method for producing a food includes, for example, a step of obtaining a composition for food by the above-mentioned method for producing a composition for food according to the present embodiment; and a step of obtaining a food by preparing ingredients including the obtained composition for food.

When the food is a bakery food, a meat processed food, a meat-like processed food, or a processed sea food, and the composition for food is blended into a dough and used, from the viewpoint of enhancing the texture of the food, and from the viewpoint of enhancing workability during production, the blending amount of the composition for food with respect to the entirety of the above-described ingredients in the step of obtaining a food is preferably equal to or more than 1% by mass, more preferably equal to or more than 2% by mass, even more preferably equal to or more than 3% by mass, still more preferably equal to or more than 5% by mass, and even more preferably equal to or more than 8% by mass.

Furthermore, from the same viewpoint, the blending amount of the composition for food with respect to the entirety of the ingredients is preferably equal to or less than 50% by mass, more preferably equal to or less than 40% by mass, even more preferably equal to or less than 30% by mass, still more preferably equal to or less than 25% by mass, and even more preferably equal to or less than 20% by mass.

When the food is a creamy food or a pasty food, and the composition for food is blended into a dough and used, from the viewpoint of enhancing the texture of the food, and from the viewpoint of enhancing workability during production, the blending amount of the composition for food with respect to the entirety of the ingredients in the step of obtaining the food is preferably equal to or more than 1% by mass, more preferably equal to or more than 2% by mass, even more preferably equal to or more than 3% by mass, still more preferably equal to or more than 5% by mass, and even more preferably equal to or more than 8% by mass.

From the same viewpoint, the blending amount of the composition for food with respect to the entirety of the ingredients is preferably equal to or less than 100% by mass, more preferably equal to or less than 99% by mass, even more preferably equal to or less than 95% by mass, and still more preferably equal to or less than 90% by mass.

When the food is a snack confectionery, and the composition for food is blended into a dough and used, from the viewpoint of enhancing the texture of the food, and from the viewpoint of enhancing workability during production, the blending amount of the composition for food with respect to the entirety of the ingredients in the step of obtaining the food is preferably equal to or more than 1% by mass, more preferably equal to or more than 2% by mass, even more preferably equal to or more than 3% by mass, still more preferably equal to or more than 5% by mass, and even more preferably equal to or more than 8% by mass.

Furthermore, from the same viewpoint, the blending amount of the composition for food with respect to the entirety of the ingredients is preferably equal to or less than 50% by mass, more preferably equal to or less than 40% by mass, even more preferably equal to or less than 30% by mass, still more preferably equal to or less than 25% by mass, and even more preferably equal to or less than 20% by mass.

When the composition for food is used as a pickling liquid or a batter liquid, from the viewpoint of enhancing the texture of the food, and from the viewpoint of enhancing workability during production, the blending amount of the composition for food with respect to the entirety of the ingredients is preferably equal to or more than 5% by mass, more preferably equal to or more than 10% by mass, even more preferably equal to or more than 20% by mass, still more preferably equal to or more than 50% by mass, even more preferably equal to or more than 80% by mass, and still more preferably 100%.

The step of obtaining a food may include cooking by heating, from the viewpoints of a bactericidal effect on the food and enhancement of storage stability. Specific examples of cooking by heating include dry heating in an oven or the like; cooking by microwave heating; cooking by heating in a steam convection oven or the like; heating on a thinly oiled frying pan or an iron plate; and deep-frying in edible oils and fats at about 100° C. to 200° C., and from the same viewpoint, heat sensing in an oven or the like or heating on a frying pan or an iron plate is preferable.

Furthermore, the step of obtaining a food does not have to include the step of cooking by heating. At this time, in the step of obtaining a food, for example, the composition for food and other ingredients may be mixed to obtain the food.

Specific examples of the obtained food include a bakery food, a meat processed food, a meat-like processed food, a processed sea food, a vegetable processed food, a fried food, snack confectionery, a pasty food, and a creamy food.

(Bakery Food)

Examples of the bakery food include yeast-fermented foods such as bread, pizza, yeast donuts, Chinese steamed buns, nans, and Danish pastry; steamed buns; cake donuts; scones; cakes such as pound cakes, sponge cakes, chiffon cakes, roll cakes, butter cakes, muffins, cup cakes, hot cakes, and pancakes; baked confectionery such as financiers, bouchees, waffles, and madeleines; and foods including no yeast, such as pies. The bakery food is preferably one kind selected from the group consisting of fermented yeast foods and cakes; more preferably one kind selected from bread, pancakes, yeast donuts and cake donuts; even more preferably one kind selected from bread, pancakes, and cake donuts; and still more preferably bread.

(Meat Processed Food)

According to the present embodiment, the composition for food is suitably used for, for example, a meat processed food, or a meat-like processed food obtained by substituting the meat in a meat processed food with a plant protein.

Specific examples of the meat processed food include nuggets such as chicken nuggets;

meat pastes for hamburg steaks, meatballs, sausages, shaomais (chinese dumplings), and gyoza dumplings; and meat fillings such as meat buns and steamed meat buns.

From the viewpoint of making the compatibility with the texture of the emulsion more preferable, the meat processed food is preferably selected from the group consisting of hamburg steaks, sausages, and nuggets.

The meat in the meat processed food may be specifically at least one kind selected from the group consisting of meat of mammals such as cows, pigs, sheep and goats; and meat of birds typified by poultry such as chickens, domestic ducks, turkeys, geese, and wild ducks. The meat is preferably at least one kind selected from the group consisting of chicken meat, pork, and beef, from the viewpoint of enhancing workability at the time of handling the composition for food.

From the same viewpoint, the meat is preferably in the form of minced meat or in the form of paste, such as minced meat or surimi.

Furthermore, in the meat-like processed food, soybean meat, insect proteins, and the like are used instead of the above-described meat.

(Processed Sea Food)

Specific examples of the processed sea food include sea food paste products such as Negitoro (minced tuna)-like foods, fish balls, hanpen (floated-type kamaboko), fish sticks, kamaboko, fish sausage, and Satsuma-age (deep-fried minced fish and vegetables); and sea food fillings.

Specific examples of the sea food in the processed sea food include fish and shellfish, such as tuna, salmon, octopus, and squid.

From the viewpoint of enhancing workability when producing a food, the sea food is preferably in the form of minced meat or in the form of paste, such as surimi.

(Pickling Liquid and Batter Liquid)

The pickling liquid is used for the purpose of improving the flavor and texture of meat processed foods or processed sea foods, and the pickling liquid is mainly added by methods such as pickling and injection. The final form of the food prepared by using the pickling liquid is not limited, and examples thereof include fried foods such as deep-fried foods, pork cutlet, chicken cutlet, and fried fish meat; and baking-cooked foods such as saute.

The batter liquid is used by adhering the batter liquid to the periphery of an ingredient when cooking by heating a food having a batter coating, for example, as in the case of a fried food and the like; and, the cooking mode is not limited to frying and may be cooking by baking. The batter liquid may be used alone as a batter coating, or may be used in combination with batter coating agents such as powders and bread crumbs. Furthermore, the final form of the food obtained by using the batter liquid is not limited, and examples include, in cases of fried foods, fried potato, tempura, deep-fried foods, pork cutlet, chicken cutlet, fried fish meat, fried shrimp, croquettes, and nuggets.

(Pasty Food and Creamy Food)

Specific examples of the pasty food and creamy food include fillings for confectionery production and breadmaking, creams for confectionery production and breadmaking, dressings, and sauces. The final form of the food obtained by using the pasty food and the creamy food according to the present embodiment is not limited. For example, the food may be used as a filling between sandwiches or may be used by spreading over a salad. Furthermore, the pasty food and the creamy food may also be cooked by heating. As specific examples of the case of cooking by heating, for example, utilization methods such as filling or topping a bakery food with a filling obtained by using the composition for food of the present embodiment, and baking the bakery food; using the composition for food as a sauce for oven-cooked foods such as gratin; or cooking the composition by frying as in the case of cream croquettes, can be adopted.

(Method for Improving Food)

The above-mentioned step of obtaining an emulsion is also suitable as a method for improving a food.

Specifically, when a dough for a bakery food is produced by mixing raw materials including the component (A), water, edible oil and fat, and an emulsifying material, for example, workability during production of a dough for a bakery food can be enhanced when the production process includes the above-mentioned step of obtaining an emulsion.

Examples of the bakery food include those mentioned above.

Furthermore, the workability is specifically the non-stickiness of a dough for a bakery food.

Furthermore, when the production process for a meat processed food or a meat-like processed food, both including raw materials including the component (A), water, edible oil and fat, and an emulsifying material, includes the above-mentioned step of obtaining an emulsion, for example, the texture of the meat processed food or the meat-like processed food can be enhanced.

Examples of the meat processed food and the meat-like processed food include those mentioned above.

Furthermore, specific examples of the texture include juicy feeling, hardness, and an elastic feeling.

Furthermore, when the production process for a food including raw materials including the component (A), water, edible oil and fat, and an emulsifying material includes the above-mentioned step of obtaining an emulsion, for example, the texture of the food after storage can be enhanced. The storage is preferably frozen storage or refrigerated storage, and specific examples of the storage temperature of these are as described above.

Furthermore, specific examples of the texture include those mentioned above.

In addition, when the production process for a food including raw materials including the component (A), water, edible oil and fat, and an emulsifying material includes the above-mentioned step of obtaining an emulsion, for example, it is also possible to enhance the flavor of a food.

The present invention includes the following aspects.

1. A method for producing a composition for food including a component (A), water, edible oil and fat, and an emulsifying material, the method including:

a step of obtaining an emulsion by mixing the component (A), the water, the edible oil and fat, and the emulsifying material,

in which the emulsifying material is at least one kind selected from the group consisting of a protein and an oil and fat-processed starch,

a content of oil and fat in the emulsion is equal to or more than 1.5 and equal to or less than 9 in terms of mass ratio with respect to the component (A), and

a total amount of the component (A), the water, the edible oil and fat, and the emulsifying material in the emulsion is equal to or more than 50% by mass and equal to or less than 100% by mass with respect to the entirety of the emulsion,

component (A): one kind or two kinds selected from the group consisting of component (A1) and component (A2):

component (A1): a powdery granular material satisfying the following conditions (1) to (4):

(1) a starch content is equal to or more than 75% by mass,

(2) a low molecular weight starch obtained from a starch having an amylose content of equal to or more than 5% by mass is included, a content of the low molecular weight starch being equal to or more than 3% by mass and equal to or less than 45% by mass, and the low molecular weight starch has a peak molecular weight of equal to or more than 3×10³ and equal to or less than 5×10⁴,

(3) a degree of swelling in cold water at 25° C. is equal to or higher than 5 and equal to or lower than 20, and

(4) a content of a fraction passing through a sieve with a mesh size of 3.35 mm and remaining on a sieve with a mesh size of 0.038 mm is equal to or more than 60% by mass and equal to or less than 100% by mass; and

component (A2): pregelatinized starch.

2. The method for producing a composition for food according to 1., in which a total content of moisture in the emulsion is more than 2 in terms of mass ratio with respect to the component (A).

3. The method for producing a composition for food according to 1. or 2., in which the edible oil and fat is one kind or two or more kinds selected from the group consisting of rapeseed oil, olive oil, lard, and milk fat.

4. The method for producing a composition for food according to any one of 1. to 3., in which the protein is one kind or two or more kinds selected from the group consisting of soybean protein, milk protein, and egg protein.

5. The method for producing a composition for food according to any one of 1. to 4., in which the emulsifying material or a formulation component including the emulsifying material is one kind or two or more kinds selected from the group consisting of soybean milk, milk, fresh cream, skim milk powder, whole milk powder, casein, egg white, and whole egg.

6. The method for producing a composition for food according to any one of 1. to 5., in which the step of obtaining an emulsion is a step of obtaining the emulsion, in which a heating yield of a dough obtained by heating the emulsion at 200° C. for 5 minutes is equal to or greater than 85% by mass and equal to or less than 100% by mass.

7. The method for producing a composition for food according to any one of 1. to 6., in which a solid fat content at 20° C. of the oil and fat in the emulsion is equal to or less than 40% by mass.

8. The method for producing a composition for food according to anyone of 1. to 7., further including, after the step of obtaining an emulsion, a step of performing a pressurized heating treatment.

9. The method for producing a composition for food according to anyone of 1. to 7., further including, after the step of obtaining an emulsion, one kind or two kinds of steps selected from the group consisting of frozen storage and refrigerated storage.

10. A method for producing a food, the method including:

a step of obtaining a composition for food by the method for producing a composition for food according to any one of 1. to 9.; and

a step of obtaining a food by preparing ingredients including the composition for food.

11. The method for producing a food according to 10., in which the step of obtaining a food includes cooking by heating.

12. A method for enhancing workability when mixing raw materials including component (A), water, edible oil and fat, and an emulsifying material to produce a dough for a bakery food,

a step of obtaining an emulsion by mixing the component (A), the water, the edible oil and fat, and the emulsifying material,

in which the emulsifying material is at least one kind selected from the group consisting of a protein and an oil and fat-processed starch,

a content of oil and fat in the emulsion is equal to or more than 1.5 and equal to or less than 9 in terms of mass ratio with respect to the component (A),

component (A): one kind or two kinds selected from the group consisting of component (A1) and component (A2):

component (A1): a powdery granular material satisfying the following conditions (1) to (4):

(1) a starch content is equal to or more than 75% by mass,

(2) a low molecular weight starch obtained from a starch having an amylose content of equal to or more than 5% by mass is included, a content of the low molecular weight starch being equal to or more than 3% by mass and equal to or less than 45% by mass, and the low molecular weight starch has a peak molecular weight of equal to or more than 3×10³ and equal to or less than 5×10⁴,

(3) a degree of swelling in cold water at 25° C. is equal to or higher than 5 and equal to or lower than 20, and

(4) a content of a fraction passing through a sieve with a mesh size of 3.35 mm and remaining on a sieve with a mesh size of 0.038 mm is equal to or more than 60% by mass and equal to or less than 100% by mass; and

component (A2): pregelatinized starch.

13. A method for enhancing a texture of a meat processed food or a meat-like processed food, both including raw materials including component (A), water, edible oil and fat, and an emulsifying material,

a step of obtaining an emulsion by mixing the component (A), the water, the edible oil and fat, and the emulsifying material,

in which the emulsifying material is at least one kind selected from the group consisting of a protein and an oil and fat-processed starch,

a content of oil and fat in the emulsion is equal to or more than 1.5 and equal to or less than 9 in terms of mass ratio with respect to the component (A),

component (A): one kind or two kinds selected from the group consisting of component (A1) and component (A2):

component (A1): a powdery granular material satisfying the following conditions (1) to (4):

(1) a starch content is equal to or more than 75% by mass,

(2) a low molecular weight starch obtained from a starch having an amylose content of equal to or more than 5% by mass is included, a content of the low molecular weight starch being equal to or more than 3% by mass and equal to or less than 45% by mass, and the low molecular weight starch has a peak molecular weight of equal to or more than 3×10³ and equal to or less than 5×10⁴,

(3) a degree of swelling in cold water at 25° C. is equal to or higher than 5 and equal to or lower than 20, and

(4) a content of a fraction passing through a sieve with a mesh size of 3.35 mm and remaining on a sieve with a mesh size of 0.038 mm is equal to or more than 60% by mass and equal to or less than 100% by mass; and

component (A2): pregelatinized starch.

14. A method for enhancing a texture after storage of a food including raw materials including component (A), water, edible oil and fat, and an emulsifying material,

a step of obtaining an emulsion by mixing the component (A), the water, the edible oil and fat, and the emulsifying material,

in which the emulsifying material is at least one kind selected from the group consisting of a protein and an oil and fat-processed starch,

a content of oil and fat in the emulsion is equal to or more than 1.5 and equal to or less than 9 in terms of mass ratio with respect to the component (A),

component (A): one kind or two kinds selected from the group consisting of component (A1) and component (A2):

component (A1): a powdery granular material satisfying the following conditions (1) to (4):

(1) a starch content is equal to or more than 75% by mass,

(2) a low molecular weight starch obtained from a starch having an amylose content of equal to or more than 5% by mass is included, a content of the low molecular weight starch being equal to or more than 3% by mass and equal to or less than 45% by mass, and the low molecular weight starch has a peak molecular weight of equal to or more than 3×10³ and equal to or less than 5×10⁴,

(3) a degree of swelling in cold water at 25° C. is equal to or higher than 5 and equal to or lower than 20, and

(4) a content of a fraction passing through a sieve with a mesh size of 3.35 mm and remaining on a sieve with a mesh size of 0.038 mm is equal to or more than 60% by mass and equal to or less than 100% by mass; and

component (A2): pregelatinized starch.

### EXAMPLES

Examples of the present invention are shown below; however, the gist of the present invention is not intended to be limited to these.

The following materials were mainly used as raw ingredients.

1. Raw Materials for Producing Emulsion

(Component (A))

(A1) Powdery granular materials 1 to 3: Powdery granular materials obtained in Production Example 2

(A2) Pregelatinized starch: Pregelatinized high-amylose cornstarch, GELCOL AH-F, manufactured by J-Oil Mills, Inc., degree of swelling in cold water 6.5

(Edible Oil and Fat)

Rapeseed oil: “AJINOMOTO Sara-sara Canola Oil”, manufactured by J-Oil Mills, Inc.

Olive oil: “Olive Oil for bakery”, manufactured by J-Oil Mills, Inc.

Lard: Pure lard, manufactured by Megmilk Snow Brand Co., Ltd.

(Emulsifying Material or Ingredient Including Emulsifying Material)

Whole milk powder: manufactured by Yotsuba Milk Products Co., Ltd. (protein content 25.5% by mass, lipid content 26.2% by mass)

Defatted soybean powder: Hotoku beans, manufactured by J-Oil Mills, Inc. (protein content 51.0% by mass, lipid content 0.7% by mass)

Skim milk powder: Skim milk powder, manufactured by Hokkaido Dairy Products Co., Ltd. (protein content 34.0% by mass, lipid content 1.0% by mass)

Milk: Hokkaido 3. 6 milk, manufactured by Takanashi Milk Products Co., Ltd. (water content 87.4% by mass, protein content 3.3% by mass, lipid content 3.6% by mass)

Fresh cream: Special Hokkaido Pure Fresh Cream 42, manufactured by Takanashi Milk Products Co., Ltd. (water content 53.0% by mass, protein content 1.9% by mass, lipid content 42.0% by mass)

Soybean milk: Plain organic soybean milk, manufactured by Tokyo Meiraku Co., Ltd. (water content 90.8% by mass, protein content 3.6% by mass, lipid content 2.0% by mass)

Whole egg (water content 76.1% by mass, protein content 12.3% by mass, lipid content 10.3% by mass)

Egg yolk (water content 48.2% by mass, protein content 16.5% by mass, lipid content 33.5% by mass)

Egg white (water content 88.4% by mass, protein content 10.5% by mass, lipid content 0% by mass)

Dried egg white: Dried Egg White W type, manufactured by Zen-noh Kewpie Egg-Station Co., Ltd. (protein content 86.5% by mass, lipid content 0.4% by mass)

Casein: Casein Sodium S, manufactured by Nippon Shinyaku Co., Ltd. (protein content 86.2% by mass, lipid content 1.5% by mass)

Whey protein (WPI): “Pronative 95”, manufactured by Lactalis Ingredients SNC (protein content 25.0% by mass, lipid content 1.2% by mass)

Oil and fat-processed starch 1: Oil and fat-processed starch obtained in Production Example 4 (protein content 0% by mass, lipid content 0.1% by mass)

Pea protein: “NUTRALYS F85M”, manufactured by Roquette Japan K.K. (protein content 85% by mass, lipid content 6% by mass)

(Others)

Lactose: LOHA Style “Lactose” (commercially available product)

Magnesium chloride: Magnesium chloride hexahydrate, manufactured by Wako Pure Chemical Industries, Ltd.

2. Other Raw Materials

Strong flour: “Eagle”, manufactured by Nippn Corporation

Dough conditioner: “Joker Kimo”, manufactured by Puratos Japan Co., Ltd.

Raw yeast: “Regular yeast”, manufactured by Oriental Yeast Co., Ltd.

Cornstarch: “Cornstarch Y”, manufactured by J-Oil Mills, Inc.

Bread crumbs: Raw Bread crumbs WRESN, manufactured by Kyoei Food Co., Ltd.

### (Production Example 1) Production of Low Molecular Weight Starch

An acid-treated high-amylose cornstarch was produced as a low molecular weight starch that was a raw material for powdery granular materials 1 to 3.

The high-amylose cornstarch (manufactured by J-Oil Mills, Inc., HS-7, amylose content 70% by mass) was suspended in water to prepare a 35.6% (w/w) slurry, and the slurry was heated to 50° C. An aqueous solution of hydrochloric acid prepared at 4.25 N was added to the slurry with stirring, the amount of the aqueous solution being 1/9 times in terms of slurry mass ratio, and a reaction was initiated. After the reaction was performed for 16 hours, the reaction mixture was neutralized with 3% Na0H, washed with water, dehydrated, and dried to obtain an acid-treated high-amylose cornstarch.

The peak molecular weight of the obtained acid-treated high-amylose cornstarch was measured by the method that will be described below, and the peak molecular weight was 1.2×10⁴.

(Method for Measuring Peak Molecular Weight)

Measurement of the peak molecular weight was carried out by using an HPLC unit manufactured by Tosoh Corporation (pump DP-8020, RI detector RS-8021, degassing apparatus SD-8022).

(1) A sample was pulverized, and a fraction of particles passing through a sieve with a mesh size of 0.15 mm was collected with sieves of the JIS-Z8801-1 standard. This collected fraction was suspended in a mobile phase at a concentration of 1 mg/mL, and the suspension was heated at 100° C. for 3 minutes to completely dissolve. Filtration was performed by using a 0.45-μm filtration filter (manufactured by ADVANTEC MFS, Inc., DISMIC-25HP PTFE 0.45 μm), and the filtrate was used as an analysis sample.

(2) The molecular weight was measured under the following analytical conditions.

Column: Two units of TSKgel α-M (7.8 mmcp, 30 cm) (manufactured by Tosoh Corporation)

Flow rate: 0.5 mL/min

Mobile phase: 5 mM sodium nitrate-containing 90% (v/v) dimethyl sulfoxide solution

Column temperature: 40° C.

Analysis amount: 0.2 mL

(3) Detector data was collected using software (MULTISTATION GPC-8020 model II data collection ver5.70, manufactured by Tosoh Corporation), and the molecular weight peak was calculated.

For the calibration curve, pullulans having known molecular weights (Shodex Standard P-82, manufactured by Showa Denko K.K.) were used.

(Method for Measuring Degree of Swelling in Cold Water)

(1) A sample was heated and dried at 125° C., the moisture was measured using a moisture meter (Kensei Kogyo Co., Ltd., model number MX-50), and the dried substance mass was calculated from the obtained moisture value.

(2) 1 g of the sample in terms of this dried substance mass was dispersed in 50 mL of water at 25° C., the dispersion was stirred gently in a constant temperature bath at 25° C. for 30 minutes, and then the dispersion was centrifuged (centrifugal separator: manufactured by Hitachi Koki Co., Ltd., Hitachi Tabletop Centrifuge CT6E type; rotor: T4SS type swing rotor; adapter: 50TC x 2S adapter) at 3000 rpm for 10 minutes to be separated into a sediment layer and a supernatant layer.

(3) The supernatant layer was removed, the mass of the sediment layer was measured, and this was designated as B (g).

(4) The mass obtained when the sediment layer was solid-dried (105° C., constant weight) was designated as C (g).

(5) The value obtained by dividing B by C was defined as the degree of swelling in cold water.

### (Production Example 2) Production of Powdery Granular Materials 1 to 4

79% by mass of cornstarch, 20% by mass of an acid-treated high-amylose cornstarch obtained in Production Example 1, and 1% by mass of calcium carbonate were mixed in a bag until the mixture became sufficiently uniform. The mixture was subjected to a pressurized heating treatment by using a twin-screw extruder (KEI-45 manufactured by Kowa Kogyo, Inc.). The processing conditions are as follows.

Raw material supply: 450 g/min

Added water: 17% by mass

Barrel temperature: 50° C., 70° C., and 100° C. increasing from the raw material inlet port toward the outlet port

Outlet port temperature: 100° C. to 110° C.

Speed of screw rotation: 250 rpm

A heating and gelatinization product obtained by an extruder treatment in this manner was dried at 110° C. to adjust the water content to 10% by mass.

Next, the dried heating and gelatinization product was pulverized with a tabletop cutter crusher, and then the pulverization product was sieved with sieves of the JIS-Z8801-1 standard. The sieved heating and gelatinization products were mixed at predetermined blending proportions to prepare powdery granular materials 1 to 4 having a particle size distribution shown in Table 1. The degrees of swelling in cold water at 25° C. of the powdery granular materials 1 to 4 measured by the above-described method are shown together in Table 1.

### (Production Example 3) Production of Powdery Granular Material

77% by mass of cornstarch, 20% by mass of an acid-treated high-amylose cornstarch, 2% by mass of a glycerin fatty acid ester, and 1% by mass of calcium carbonate were mixed in a bag until the mixture was sufficiently uniform. The mixture was subjected to a pressurized heating treatment by using a twin-screw extruder (KEI-45 manufactured by Kowa Kogyo, Inc.). The processing conditions are as follows.

Raw material supply: 450 g/min

Added water: 17% by mass

Barrel temperature: 50° C., 70° C., and 100° C. increasing from the raw material inlet port toward the outlet port

Outlet port temperature: 100° C. to 110° C.

Speed of screw rotation: 250 rpm

A heating and gelatinization product obtained by an extruder treatment in this manner was dried at 110° C. to adjust the water content to 10% by mass.

Next, the dried heating and gelatinization product was pulverized with a tabletop cutter crusher, and then the pulverization product was sieved with sieves of the JIS-Z8801-1 standard. The sieved heating and gelatinization products were mixed at predetermined blending proportions to prepare a powdery granular material 5 having a particle size distribution shown in Table 1. The degree of swelling in cold water at 25° C. of the powdery granular material 5 measured by the above-described method is shown in Table 1.

TABLE 1

| | | Powdery | Powdery | Powdery | Powdery | Powdery |
|---|---|---|---|---|---|---|
| | | granular | granular | granular | granular | granular |
| | | material 1 | material 2 | material 3 | material 4 | material 5 |
| Fraction | Passing through sieve with | | | 0.2 | | |
| (% by | 3.35 mm mesh size and | | | | | |
| mass) | remaining on sieve with 1.4 | | | | | |
| | mm mesh size | | | | | |
| | Passing through sieve with | | | 13.2 | | |
| | 1.4 mm mesh size and | | | | | |
| | remaining on sieve with 1 mm | | | | | |
| | mesh size | | | | | |
| | Passing through sieve with 1 | | 18.0 | 38.5 | | |
| | mm mesh size and remaining | | | | | |
| | on sieve with 0.5 mm mesh | | | | | |
| | size | | | | | |
| | Passing through sieve with | | 42.0 | 19.5 | | 0.81 |
| | 0.5 mm mesh size and | | | | | |
| | remaining on sieve with 0.25 | | | | | |
| | mm mesh size | | | | | |
| | Passing through sieve with | 36.4 | 15.0 | 10.4 | | 10.8 |
| | 0.25 mm mesh size and | | | | | |
| | remaining on sieve with 0.15 | | | | | |
| | mm mesh size | | | | | |
| | Passing through sieve with | 48.0 | 20.0 | 13.7 | | 64.8 |
| | 0.15 mm mesh size and | | | | | |
| | remaining on sieve with | | | | | |
| | 0.075 mm mesh size | | | | | |
| | Passing through sieve with | 11.4 | 3.7 | 3.3 | 62.4 | 22.1 |
| | 0.075 mm mesh size and | | | | | |
| | remaining on sieve with | | | | | |
| | 0.038 mm mesh size | | | | | |
| | Passing through sieve with | 4.2 | 1.3 | 1.2 | 37.6 | 1.5 |
| | 0.038 mm mesh size | | | | | |
| | Total | 100.0 | 100.0 | 100.0 | 100.0 | 100.0 |
| | Passing through sieve with | 95.8 | 98.7 | 98.8 | 62.4 | 98.5 |
| | 3.35 mm mesh size and | | | | | |
| | remaining on sieve with | | | | | |
| | 0.038 mm mesh size | | | | | |
| | Passing through sieve with | 84.4 | 77.0 | 43.6 | 0.0 | 76.4 |
| | 0.5 mm mesh size and | | | | | |
| | remaining on sieve with | | | | | |
| | 0.075 mm mesh size | | | | | |
| | Passing through sieve with | 95.8 | 38.7 | 27.4 | 62.4 | 97.7 |
| | 0.25 mm mesh size and | | | | | |
| | remaining on sieve with | | | | | |
| | 0.038 mm mesh size | | | | | |

| | | | | | |
|---|---|---|---|---|---|
| Degree of swelling in cold water | 8.3 | 10.5 | 7.3 | 8.6 | 7.4 |

### (Production Example 4) Production of Oil and Fat-Processed Starch

0.1 parts by mass of high-linoleic acid safflower oil, 0.05 parts by mass of diglycerin monooleic acid ester, and, 0.4 parts by mass of a 25% aqueous solution of sodium carbonate (0.1 parts by mass in terms of sodium carbonate equivalent) were added to 100 parts by mass of phosphate-crosslinked tapioca starch (Actobody TP-1, manufactured by J-Oil Mills, Inc.), and the components were uniformly mixed with a mixer (Super Mixer, manufactured by Kawata Co., Ltd.) at 3000 rpm for 3 minutes to obtain a mixture.

This mixture was heated at 70° C. for 10 days in a shelf-type dryer, and oil and fat-processed starch 1 was obtained.

### Examples 1 to 7, Comparative Example 1, Control Example 1

In the present examples, compositions for food were produced, and production of bread using the obtained compositions for food and evaluation thereof were carried out.

(Method for Producing Bread)

1. Pretreatment

1-1. For examples other than Comparative Example 1, formulation components including edible oil and fat, component (A), and an emulsifying material (protein) were put into a mixer bowl according to the formulations described in Table 2 and were mixed in a desktop mixer (Hobart Mixer N50, manufactured by Mixer Hobart Japan K.K.) using a beater.

1-2. Water was added, and for Examples 1 to 7, a mixture in a uniformly emulsified state (emulsions) was obtained. For Control Example 1, a mixture exhibiting a state of separation of the components was obtained.

2. In Control Example 1 and Examples 1 to 7, dough raw materials other than the mixture or emulsion were mixed with a bread mixer (Kanto Mixer HP-20M, manufactured by Kanto Kongoki Industrial Co., Ltd.), and a mixture was obtained. The mixing condition is main kneading mixing 1 described in Table 3. Next, the mixture obtained by the pretreatment was added, and the mixtures were mixed with a bread mixer until a dough was put together. The mixing condition is main kneading mixing condition 2 described in Table 3.

On the other hand, in Comparative Example 1, all the ingredients described in Table 3 were mixed with a bread mixer, and a mixture was obtained. The mixing condition is main kneading mixing condition 1.

3. After mixing, the dough was taken out of the mixer and was fermented at 27° C. for 60 minutes.

4. The dough was divided into pieces weighing 130 g, and the pieces were each rolled and rested for 20 minutes and then rolled and stuffed in a one-loaf mold, with three pieces in each mold.

5. The formed dough pieces were fermented in a proofer at 36° C. and 80% for 70 minutes.

6. After fermentation, the dough pieces were baked in an oven under the following conditions and time.

Baking conditions: Upper tier 190° C./220° C.

Baking time: 25 minutes

7. After baking, the heat of the baked bread just after cooking was removed at room temperature (20° C.)

For each example, the workability at the time of producing bread dough and the texture and external appearance of the obtained bread were evaluated. The evaluation results are shown together in Table 3.

(Workability)

One specialized panelist evaluated the workability (stickiness of the bread dough) during the production of the bread dough on a five-point scale according to the following criteria. A score of equal to or higher than 3 was considered acceptable.

5: Almost non-sticky and very easy to work with

4: Slightly sticky but easy to work with

3: A little sticky but ignorable in view of working

2: Sticky and difficult to work with

1: Very sticky and very difficult to work with

(Texture)

The moist feeling of bread and the absence of remains in mouth were evaluated by four specialized panelists according to the following criteria, and the average score of the four panelists was employed as the score. A score of equal to or higher than 3 was considered acceptable.

(Moist Feeling)

5: There is a highly moist feeling

4: There is a moist feeling

3: There is a slightly moist feeling

2: There is not much moist feeling

1: There is hardly a moist feeling

(Absence of Remains in Mouth)

5: No remains in mouth is left when chewed

4: Almost no remains in mouth is left when chewed

3: A little remains in mouth is left when chewed but ignorable

2: Turns into a slightly dumpling-like form when chewed, and a slight remains in mouth is left

1: Turns into a dumpling-like form when chewed, and a remains in mouth is left

(External Appearance and Inner Layers)

The appearance and inner layer of the bread were evaluated by visual inspection by one specialized panelist on a five-point scale according to the following criteria, and a score of equal to or higher than 3 was considered acceptable.

(External Appearance)

5: There is a voluminous feeling, and the baked color is also satisfactory

4: There is a little voluminous feeling, and the baked color is also a little satisfactory

3: The voluminous feeling is adequate, and the baked color is adequate

2: The voluminous feeling is slightly lacking, and the baked color is slightly non-uniform

1: The voluminous feeling is lacking, and the baked color is defective

(Inner Layers)

5: Completely uniform inner layers with very fine texture

4: Almost uniform inner layers with fine texture

3: Slightly uniform inner layers with slightly fine texture

2: Slightly non-uniform inner layers with a slightly thick dough film

1: Non-uniform inner layers with a thick dough film

TABLE 2

| | | Control | Comparative | | | | | | | |
|---|---|---|---|---|---|---|---|---|---|---|
| | Raw ingredient | Exam- | Exam- | Exam- | Exam- | Exam- | Exam- | Exam- | Exam- | Exam- |
| | (parts by mass) | ple 1 | ple 1 | ple 1 | ple 2 | ple 3 | ple 4 | ple 5 | ple 6 | ple 7 |
| Mixture* or | (A1) Powdery granular | | | 5 | 2.5 | 5 | 5 | 5 | 5 | 5 |
| emulsion | material 1 | | | | | | | | | |
| | Rapeseed oil | | | | | | | 20 | 20 | 9.1 |
| | Olive oil | 20 | | 20 | 10 | 30 | 20 | | | |
| | Skim milk powder | | | 1.5 | 0.75 | | | | | |
| | Whole egg | | | | | 4.1 | 4.1 | | | |
| | Egg white | | | | | | | 4.8 | | |
| | Milk | | | | | | | | 7.6 | |
| | Fresh cream | | | | | | | | | 26 |
| | Water | 20 | | 20 | 10 | 17 | 17.0 | 15.8 | 13.4 | 6.2 |

| | | | | | | | | | |
|---|---|---|---|---|---|---|---|---|---|
| Protein/(A) (% by mass) | — | — | 10.2 | 10.2 | 10.2 | 10.1 | 10.1 | 5 | 10 |
| Total water portion in emulsion (% by mass) | — | — | 43.0 | 43.0 | 35.9 | 43.6 | 44.0 | 43.6 | 43.2 |
| Total oil portion in emulsion (% by mass) | — | — | 43.0 | 43.0 | 54.2 | 44.3 | 43.9 | 44.1 | 43.2 |
| Oil portion/(A) (mass ratio) | — | — | 4.0 | 4.0 | 6.1 | 4.1 | 4.0 | 4.1 | 4.0 |
| ((A) + water + edible oil and fat + | — | — | 100.0 | 100.0 | 100.0 | 100.0 | 100.0 | 100.0 | 100.0 |
| emulsifying material)/emulsion (% by mass) | | | | | | | | | |

*Mixture: Control Example 1

TABLE 3

| | | Control | Comparative | | | |
|---|---|---|---|---|---|---|
| | | Example 1 | Example 1 | Example 1 | Example 2 | Example 3 |
| Main | Mixture** or emulsion | 40 (mixture) | | 46.5 | 23.3 | 56.1 |
| kneading | (composition for food) | | | | | |
| formulation | (A1) Powdery granular material 1 | | 5 | | | |
| (parts by | Olive oil | | 20 | | | |
| mass) | Skim milk powder | | 1.5 | | | |
| | Water | | 20 | | | |
| | Strong flour | 100 | 95 | 95 | 95 | 95 |
| | Dough conditioner | 0.3 | 0.3 | 0.3 | 0.3 | 0.3 |
| | Raw yeast | 3 | 3 | 3 | 3 | 3 |
| | Salt | 2 | 2 | 2 | 2 | 2 |
| | White sugar | 12 | 12 | 12 | 12 | 12 |
| | Whole egg | 12 | 12 | 12 | 12 | 12 |
| | Water | 55 | 55 | 55 | 55 | 55 |
| | Total amount of dough | 184.3 | 225.8 | 225.8 | 202.55 | 235.4 |
| Evaluation | Main kneading mixing condition 1 | Hooking | Hooking | Hooking | Hooking | Hooking |
| | | Speed 1 for 3 min | Speed 1 for 6 min | Speed 1 for 3 min | Speed 1 for 3 min | Speed 1 for 3 min |
| | | Speed 2 for 8 min | for 6 min | Speed 2 for 6 min | Speed 2 for 6 min | Speed 2 for 6 min |
| | | Speed 3 for 5 min | for 18 min | Speed 3 for 2 min | Speed 3 for 2 min | Speed 3 for 2 min |
| | Main kneading mixing condition 2 | Hooking | Dough not put | Hooking | Hooking | Hooking |
| | | Speed 1 for 5 min | together | Speed 1 for 4 min | Speed 1 for 2 min | Speed 1 for 3 min |
| | | Speed 2 for 6 min | | Speed 2 for 2 min | 30 sec | Speed 2 for 2 min |
| | | Speed 3 for 9 min | | | Speed 2 for 2 min | |
| | | Dough not put | | | | |
| | | together | | | | |
| | Total main kneading mixing time | 36 min | 30 min | 17 min | 15 min 30 sec | 16 min |
| | Stickiness of bread dough | 1 | 1 | 5 | 5 | 4 |
| | Moist feeling | 1.75 | 2.25 | 4.75 | 3.25 | 5 |
| | Absence of remains in mouth | 1.25 | 2.25 | 4.75 | 3 | 4.75 |
| | External appearance of bread | 1 | 1 | 4 | 5 | 5 |
| | dough after baking | | | | | |
| | Inner layers of bread dough | 1 | 1 | 4 | 5 | 5 |
| | after baking | | | | | |

| | | Example 4 | Example 5 | Example 6 | Example 7 |
|---|---|---|---|---|---|
| Main | Mixture** or emulsion | 46.1 | 45.6 | 46.0 | 46.3 |
| kneading | (composition for food) | | | | |
| formulation | (A1) Powdery granular material 1 | | | | |
| (parts by | Olive oil | | | | |
| mass) | Skim milk powder | | | | |
| | Water | | | | |
| | Strong flour | 95 | 95 | 95 | 95 |
| | Dough conditioner | 0.3 | 0.3 | 0.3 | 0.3 |
| | Raw yeast | 3 | 3 | 3 | 3 |
| | Salt | 2 | 2 | 2 | 2 |
| | White sugar | 12 | 12 | 12 | 12 |
| | Whole egg | 12 | 12 | 12 | 12 |
| | Water | 55 | 55 | 55 | 55 |
| | Total amount of dough | 225.4 | 224.9 | 225.3 | 225.6 |
| Evaluation | Main kneading mixing condition 1 | Hooking | Hooking | Hooking | Hooking |
| | | Speed 1 for 3 min | Speed 1 for 3 min | Speed 1 for 3 min | Speed 1 for 3 min |
| | | Speed 2 for 6 min | Speed 2 for 6 min | Speed 2 for 6 min | Speed 2 for 6 min |
| | | Speed 3 for 2 min | Speed 3 for 2 min | Speed 3 for 2 min | Speed 3 for 2 min |
| | Main kneading mixing condition 2 | Hooking | Hooking | Hooking | Hooking |
| | | Speed 1 for 3 min | Speed 1 for 3 min | Speed 1 for 4 min | Speed 1 for 4 min |
| | | Speed 2 for 2 min | Speed 2 for 2 min | Speed 2 for 2 min | Speed 2 for 2 min |
| | Total main kneading mixing time | 16 min | 16 min | 17 min | 17 min |
| | Stickiness of bread dough | 5 | 5 | 4 | 4 |
| | Moist feeling | 5 | 4.75 | 4.75 | 5 |
| | Absence of remains in mouth | 4.5 | 4.5 | 5 | 4.75 |
| | External appearance of bread | 5 | 4 | 4 | 5 |
| | dough after baking | | | | |
| | Inner layers of bread dough | 5 | 5 | 4 | 5 |
| | after baking | | | | |

**Mixture is added without being emulsified

### Example 8 and Comparative Example 2

In Example 8, an emulsion was produced according to Example 1 and the like, except that the components of the emulsion and formulation were adjusted to the content described in Table 4.

Bread was produced under the following conditions by using a composition for food formed from the obtained emulsion.

1. The dough raw materials other than the obtained emulsion were mixed with a bread mixer (Kanto Mixer HP-20M, manufactured by Kanto Kongoki Industrial Co., Ltd.), and a mixture was obtained. The mixing condition is main kneading mixing 1.

2. In Example 8, the emulsion obtained by the pretreatment was added, and the mixture and the emulsion were mixed with a bread mixer until a dough was put together. In Comparative Example 2, the components described in Table 4 were mixed altogether, and a mixture was obtained.

3. After mixing, the dough was taken out of the mixer and was fermented at 27° C. for 60 minutes.

4. The dough was divided into pieces weighing 130 g, and the pieces were each rolled and rested for 20 minutes and then rolled and stuffed in a one-loaf mold, with three pieces in each mold.

5. The formed dough pieces were fermented in a proofer at 36° C. and 80% for 70 minutes.

6. After fermentation, the dough pieces were baked in an oven under the following conditions and time.

Baking conditions: Upper tier 190° C./220° C.

Baking time: 25 minutes

7. After baking, the heat of the baked bread just after cooking was removed at room temperature (20° C.)

For the bread obtained in Example 8, the texture was evaluated after 3 days at room temperature, and the texture was more preferable than that of Comparative Example 2 in terms of softness and a moist texture. Regarding the swelling of the bread, Example 8 was voluminous and satisfactory as compared with Comparative Example 2.

TABLE 4

| | | | Comparative | Example |
|---|---|---|---|---|
| | | | Example 2 | 8 |
| Formulation | Other raw | Strong | 100 | 95 |
| (parts by mass) | ingredients | flour | | |
| | | Dough | 0.3 | 0.3 |
| | | conditioner | | |
| | | Raw yeast | 3 | 3 |
| | | Salt | 2 | 2 |
| | | White sugar | 12 | 12 |
| | | Whole egg | 12 | 12 |
| | | Water | 32 | 55 |
| | | absorption | | |
| | Emulsion | (A1) | — | 5 |
| | (composition for | Powdery | | |
| | food) | granular | | |
| | | material 1 | | |
| | | Olive oil | 20 | 20 |
| | | Soybean | 20 | 20 |
| | | milk | | |

| | | |
|---|---|---|
| Total amount of dough | 201.3 | 224.3 |

| | | |
|---|---|---|
| Protein/(A) (% by mass) | — | 14.4 |
| Total water portion in emulsion (% by mass) | — | 40.4 |
| Total oil portion in emulsion (% by mass) | — | 45.3 |
| Oil portion/(A) (mass ratio) | — | 4.1 |
| ((A) + water + edible oil and fat + emulsifying | — | 100.0 |
| material)/emulsion (% by mass) | | |

### Examples 9 to 12 and Control Example 2

In the present examples, production and evaluation of hamburg steaks were carried out by using a composition for food formed from the emulsion.

(Method for Producing Hamburg Steak)

A hamburg steak was produced by the following procedure by using a composition for food formed from the emulsion obtained in each example and the components described in Table 5 according to the formulation described in Table 5.

1. Raw materials treatment and mixing: The components of (1) in Table 5, that is, meat and salt, were mixed in advance to make them sticky.

2. In addition, after lightly mixing the components by hand, the mixture was mixed with a Kenmix Mixer at a strength of 2 for 3 minutes.

3. Sample mixing: The components of (2) in Table 5 were mixed in advance, and then the mixture was mixed into the mixture of 2. by hand.

4. The components of (3) in Table 5 were mixed to produce an emulsion, and the emulsion was added to the mixture of 3.

5. Kneading: Performed under the conditions at a Kenmix Mixer strength of 1 for 1 minute.

6. Shaping: Adjusted to 100 g/piece.

7. Baking: Baked by iron plate cooking (with grilled marks) at 200° C. for 1 minute each on the front and back sides.

8. Oven cooking: Cooked for 7 minutes without steaming at 200° C.

9. Allowed to cool.

10. After allowing to cool at normal temperature of 25° C. for 30 minutes, reheating was performed at 500 W for 1 minute, and the cooked product was evaluated by eating.

Furthermore, at a later date, after refrigerated storage, the cooked product was reheated and evaluated. Specifically, the cooked product was stored under refrigeration at 5° C. for 3 days, subsequently reheated by microwaving at 500 W for 1.5 minutes, and evaluated by eating.

For each example, the yield after baking of the hamburg steak was calculated. Furthermore, the texture of the hamburg steak obtained in each example was evaluated according to the following criteria. One specialized panelist evaluated each of the following items on a five-point scale (increment being 0.5 points) according to the following criteria, and a score of higher than 2 points was considered acceptable.

These results are shown in Table 6.

Furthermore, in each Example, the workability when producing the hamburg steak dough by using the emulsion was preferable in all cases.

(Juicy Feeling)

5: There is an extremely succulent feeling when chewed.

4: There is a highly succulent feeling when chewed.

3: There is a succulent feeling when chewed.

2: There is some succulent feeling when chewed.

1: There is no succulent feeling when chewed, and it is dry.

(Hardness/Elastic Feeling)

5: The overall hardness and elastic feeling are very strong.

4: The overall hardness and elastic feeling are strong.

3: There is overall hardness and elastic feeling.

2: There is slight overall hardness and elastic feeling.

1: There is no overall hardness and elastic feeling, and it is soft.

(Meat Grain Feeling)
5: The grain feeling and fibrous feeling of meat are very strong.
4: The grain feeling and fibrous feeling of meat are strong.
3: There is a grain feeling and a fibrous feeling of meat.
2: There is a slight grain feeling and fibrous feeling of meat.
1: There is no grain feeling or fibrous feeling of meat, and there is a homogenous texture.

TABLE 5

| | | | Control | | | | |
|---|---|---|---|---|---|---|---|
| | | | Example 2 | Example 9 | Example 10 | Example 11 | Example 12 |
| Formulation | (1) Beef | | 33.0 | 33.0 | 33.0 | 33.0 | 33.0 |
| (unit: parts) | (lean meat | | | | | | |
| | 80%) | | | | | | |
| | (1) Chicken | | 18.0 | 18.0 | 18.0 | 18.0 | 18.0 |
| | (1) Pork | | 5.0 | 5.0 | 5.0 | 5.0 | 5.0 |
| | (1) Table | | 0.6 | 0.6 | 0.6 | 0.6 | 0.6 |
| | salt | | | | | | |
| | (1) Lard | | 4.0 | 4.0 | 4.0 | 2.0 | 0.0 |
| | (2) Onion | | 23.5 | 23.5 | 23.5 | 23.5 | 23.5 |
| | (raw) | | | | | | |
| | (2) Egg | | 6.0 | 6.0 | 6.0 | 4.0 | 2.0 |
| | white | | | | | | |
| | (2) | | 0.6 | 0.6 | 0.6 | 0.6 | 0.6 |
| | Cornstarch | | | | | | |
| | (2) Sugar | | 0.1 | 0.1 | 0.1 | 0.1 | 0.1 |
| | (2) Spice | | 0.1 | 0.1 | 0.1 | 0.1 | 0.1 |
| | (black | | | | | | |
| | pepper) | | | | | | |
| | (2) Umami | | 0.1 | 0.1 | 0.1 | 0.1 | 0.1 |
| | seasoning | | | | | | |
| | (2) Bread | | 7.0 | 7.0 | 7.0 | 7.0 | 7.0 |
| | crumbs | | | | | | |
| | (2) Water | | 2.0 | 2.0 | 2.0 | 2.0 | 2.0 |
| | Emulsion | (3) (A1) | | 0.5 | 1.0 | 0.5 | 1.0 |
| | (composition | Powdery | | | | | |
| | for food) | granular | | | | | |
| | | material 1 | | | | | |
| | | (3) Dried | | 0.2 | 0.4 | 0.2 | 0.5 |
| | | egg white | | | | | |
| | | (3) Canola | | 2.0 | 4.0 | 0.0 | 0.0 |
| | | oil | | | | | |
| | | (3) Lard | | 0.0 | 0.0 | 2.0 | 4.0 |
| | | (3) Water | | 2.0 | 4.0 | 1.8 | 3.5 |

| | | | | | |
|---|---|---|---|---|---|
| Total | 100.0 | 104.7 | 109.4 | 100.5 | 101.0 |

| | | | | | |
|---|---|---|---|---|---|
| Protein/(A) (% by mass) | — | 36.6% | 36.6% | 43.9% | 43.9% |
| Total water portion in emulsion (% by mass) | — | 42.6% | 42.6% | 39.6% | 39.0% |
| Total oil portion in emulsion (% by mass) | — | 100% | 42.6% | 44.1% | 44.6% |
| Oil portion/(A) (mass ratio) | — | 4.0 | 4.0 | 4.0 | 4.0 |
| ((A) + water + edible oil and fat + | — | 100% | 100% | 100% | 100% |
| emulsifying material)/emulsion (% by | | | | | |
| mass) | | | | | |

*Remark) Component (A) and dried egg white were calculated to have a solid content of 100% (water fraction value 0).

TABLE 6

| | | Control | | | | |
|---|---|---|---|---|---|---|
| | | Example 2 | Example 9 | Example 10 | Example 11 | Example 12 |
| Yield | Weight | 199.8 | 204.9 | 201.5 | 202.7 | 201.8 |
| | before | | | | | |
| | baking, g | | | | | |
| | Weight after | 170.1 | 174.5 | 171.1 | 172.9 | 174.3 |
| | baking, g | | | | | |
| | Baking | 85.1% | 85.2% | 84.9% | 85.3% | 86.4% |
| | yield % | | | | | |
| Evaluation of | Juicy | 3 | 4.5 | 4.5 | 4 | 4.5 |
| texture (after | feeling | | | | | |
| production) | Hardness and | 3 | 3 | 3 | 3.5 | 3 |
| | elastic | | | | | |
| | feeling | | | | | |
| | Meat grain | 3 | 3 | 2.5 | 3 | 2.5 |
| | feeling | | | | | |
| Evaluation of | Juicy | 2 | 3.5 | 3.5 | 3 | 3.5 |
| texture | feeling | | | | | |
| (refrigeration | Hardness and | 3.5 | 3.5 | 3.5 | 4 | 3.5 |
| D + 3) | elastic | | | | | |
| | feeling | | | | | |
| | Meat grain | 3 | 3 | 2.5 | 3 | 2.5 |
| | feeling | | | | | |

### Preparation Examples 1 to 21

An emulsion (composition for food) of each example was prepared according to the formulation described in Tables 7 to 9. The mixing method and conditions in each example and the properties of the obtained emulsion (emulsified dough) are shown together in Tables 7 to 9.

(State of Dough)

In each example, the state of the obtained emulsified dough was evaluated. With regard to the evaluation, after 1 hour after mixing, one worker evaluated the state by visual inspection according to the following criteria, and a score of equal to or higher than 2 points was considered acceptable. The results are shown together in Table 7 to Table 9.

4: The shape at the time of mixing is maintained, and an oil content is not at all separated.

3: The shape at the time of mixing is maintained, and an oil content is almost not separated.

2: The shape at the time of mixing changes a little, and slight separation of an oil content is observed at the surface but to an allowable extent.

1: The dough is not put together even when mixed, and the dough is watery/the shape at the time of mixing is not maintained, and a large amount of separation of oil and fat is observed.

(Heating Yield)

About 65 g (60 to 70 g) of the emulsion obtained in each example was scooped up with an ice cream disher and placed on a cooking sheet, and the mass of the emulsion before heating was measured. The emulsion together with the cooking sheet was placed in a convection oven (dry heat) heated to 200° C. and heated for 5 minutes, subsequently only the emulsion was immediately transferred onto a tray, and the mass after heating was measured. The heating yield was calculated by the following formula.

Mass after heating/mass before heating×100 (%)

TABLE 7

| | | Preparation | Preparation | Preparation | Preparation |
|---|---|---|---|---|---|
| | | Example 1 | Example 2 | Example 3 | Example 4 |
| Raw | (A1) Powdery granular material 1 | 50 | 50 | 50 | 50 |
| material | Rapeseed oil | 200 | 195 | 200 | 200 |
| (parts by | Casein Na | 8 | | | |
| mass) | Whey (WPI) | 2 | | | |
| | Lactose | 15 | | | |
| | 20% Mg chloride solution | 7.5 | | | |
| | Whole milk powder | | 20 | | |
| | Skim milk powder | | | 15 | |
| | Milk | | | | 150 |
| | Defatted soybean powder | | | | |
| | Soybean milk | | | | |
| | Water | 200 | 200 | 200 | 70 |
| Mixing method | | Kenmix mixer | Kenmix mixer | Kenmix mixer | Kenmix mixer |
| | | (strength 1 | (strength 1 | (strength 1 | (strength 1 |
| | | for 7 min) | for 7 min) | for 7 min) | for 7 min) |
| Form of dough | | Semisolid | Pasty | Pasty | Creamy |
| | | form | | | |
| State of dough | | 4 | 4 | 4 | 4 |
| Heating yield (heated retention properties) | | 97.4% | 95.5% | 90.8% | 92.1% |
| Protein/(A) (% by mass) | | 7.9 | 10.2 | 10.2 | 9.9 |
| Total water portion in emulsion (% by mass) | | 41.5 | 43.0 | 43.0 | 42.8 |
| Total oil portion in emulsion (% by mass) | | 41.5 | 43.1 | 43.0 | 43.7 |
| Oil portion/(A) (mass ratio) | | 4.0 | 4.0 | 4.0 | 4.1 |
| ((A) + water + edible oil and fat + emulsifying | | 95.3 | 100 | 100 | 100.0 |
| material)/emulsion (% by mass) | | | | | |
| | | Preparation | Preparation | Preparation | Preparation |
| | | Example 5 | Example 6 | Example 7 | Example 8 |
| Raw | (A1) Powdery granular material 1 | 50 | 50 | 50 | 50 |
| material | Rapeseed oil | 200 | 200 | 197 | 200 |
| (parts by | Casein Na | | | | |
| mass) | Whey (WPI) | | | | |
| | Lactose | | | | |
| | 20% Mg chloride solution | | | | |
| | Whole milk powder | | | | |
| | Skim milk powder | | | | |
| | Milk | 76 | | | |
| | Defatted soybean powder | | 10 | | |
| | Soybean milk | | | 140 | 70 |
| | Water | 134 | 200 | 73 | 136 |

| | | | | |
|---|---|---|---|---|
| Mixing method | Kenmix mixer | Kenmix mixer | Kenmix mixer | Kenmix mixer |
| | (strength 1 | (strength 1 | (strength 1 | (strength 1 |
| | for 7 min) | for 7 min) | for 7 min) | for 7 min) |
| Form of dough | Creamy | Creamy | Loose | Loose |
| | | | paste-like | paste-like |
| State of dough | 4 | 4 | 4 | 4 |
| Heating yield (heated retention properties) | 94.0% | 93.2% | 92.8% | 93.2% |
| Protein/(A) (% by mass) | 5 | 10.2 | 10.1 | 5 |
| Total water portion in emulsion (% by mass) | 43.6 | 43.5 | 43.5 | 43.8 |
| Total oil portion in emulsion (% by mass) | 44.1 | 43.5 | 43.4 | 44.2 |
| Oil portion/(A) (mass ratio) | 4.1 | 4.0 | 4.0 | 4.0 |
| ((A) + water + edible oil and fat + emulsifying | 100.0 | 100.0 | 100.0 | 100.0 |
| material)/emulsion (% by mass) | | | | |

*Remark) Component (A) and dried egg white were calculated to have a solid content of 100% (water fraction value 0).

TABLE 8

| | | Preparation | Preparation | Preparation | Preparation | Preparation | Preparation | Preparation |
|---|---|---|---|---|---|---|---|---|
| | | Example 9 | Example 10 | Example 11 | Example 12 | Example 13 | Example 14 | Example 15 |
| Raw | (A1) Powdery granular | 50 | 50 | 50 | | | 50 | |
| material | material 1 | | | | | | | |
| (parts | (A1) Powdery granular | | | | 50 | | | |
| by mass) | material 2 | | | | | | | |
| | (A1) Powdery granular | | | | | 50 | | |
| | material 3 | | | | | | | |
| | (A2) Pregelatinized starch | | | | | | | 50 |
| | Rapeseed oil | 200 | 200 | 200 | 200 | 200 | 250 | 200 |
| | Egg white | 48 | | | | | | |
| | Dried egg white | | 10 | 20 | 20 | 20 | 20 | |
| | Skim milk powder | | | | | | | 30 |
| | Water | 158 | 200 | 200 | 200 | 200 | 200 | 150 |

| | | | | | | | |
|---|---|---|---|---|---|---|---|
| Mixing method | Kenmix | Kenmix | Kenmix | Kenmix | Kenmix | Kenmix | Kenmix |
| | mixer | mixer | mixer | mixer | mixer | mixer | mixer |
| | (strength 1 | (strength 1 | (strength 1 | (strength 1 | (strength 1 | (strength 1 | (strength 1 |
| | for 7 min) | for 7 min) | for 7 min) | for 7 min) | for 7 min) | for 7 min) | for 7 min) |
| Form of dough | Loose | Loose | Pasty | Loose | Fairly | Loose | Creamy |
| | cream-like | paste-like | | paste-like | loose | paste-like | |
| | | | | | paste-like | | |
| State of dough | 3 | 4 | 4 | 4 | 3 | 4 | 4 |
| Heating yield (heated retention | 97.3% | 95.2% | 94.9% | 95.5% | 94.0% | 96.3% | 95.0% |
| properties) | | | | | | | |
| Protein/(A) (% by mass) | 10.1 | 17.3 | 34.6 | 34.6 | 34.6 | 34.6 | 20.4 |
| Total water portion in emulsion (% | 44.0 | 43.5 | 42.6 | 42.6 | 42.6 | 38.5 | 34.9 |
| by mass) | | | | | | | |
| Total oil portion in emulsion (% by | 43.9 | 43.5 | 42.6 | 42.6 | 42.6 | 48.1 | 46.6 |
| mass) | | | | | | | |
| Oil portion/(A) (mass ratio) | 4.0 | 4.0 | 4.0 | 4.0 | 4.0 | 5.0 | 4.0 |
| ((A) + water + edible oil and fat + | 100.0 | 100.0 | 100.0 | 100.0 | 100.0 | 100.0 | 100.0 |
| emulsifying | | | | | | | |
| material)/emulsion (% by mass) | | | | | | | |

*Remark) Component (A) and dried egg white were calculated to have a solid content of 100% (water fraction value 0).

TABLE 9

| | | Preparation | Preparation | Preparation | Preparation | Preparation | Preparation |
|---|---|---|---|---|---|---|---|
| | | Example 16 | Example 17 | Example 18 | Example 19 | Example 20 | Example 21 |
| Emulsifying method | | Kenmix | Kenmix | Kenmix | Cutter | Hand mixing | Kenmix |
| | | (strength 1 | (strength 1 | (strength 3 | mixer 15 sec | (5 min) | (strength 1 |
| | | for 5 min) | for 7 min) | for 5 min) | | | for 5 min) |
| Raw | (A1) Powdery | 50 | 50 | 50 | 50 | 50 | 50 |
| material | granular | | | | | | |
| (parts | material 1 | | | | | | |
| by mass) | Rapeseed oil | 200 | 200 | 200 | 200 | 200 | 200 |
| | Skim milk powder | 15 | 15 | 15 | 15 | 15 | 30 |
| | Water | 200 | 200 | 200 | 200 | 200 | 200 |

| | | | | | | |
|---|---|---|---|---|---|---|
| Form of dough | Pasty | Semisolid | Semisolid | Loose | Pasty | Semisolid |
| | | form | form | paste-like | | form |
| State of dough | 3 | 4 | 2 | 3 | 3 | 4 |
| Heating yield | 90.8% | 95.3% | 92.9% | 95.2% | 92.7% | 97.0% |
| (heated retention | | | | | | |
| properties) | | | | | | |
| Protein/(A) (% by mass) | 10.2 | 10.2 | 10.2 | 10.2 | 10.2 | 20.4 |
| Total water portion in | 43.0 | 43.0 | 43.0 | 43.0 | 43.0 | 41.7 |
| emulsion (% by mass) | | | | | | |
| Total oil portion in | 43.0 | 43.0 | 43.0 | 43.0 | 43.0 | 41.7 |
| emulsion (% by mass) | | | | | | |
| Oil portion/(A) (mass | 4.0 | 4.0 | 4.0 | 4.0 | 4.0 | 4.0 |
| ratio) | | | | | | |
| ((A) + water + edible oil | 100.0 | 100.0 | 100.0 | 100.0 | 100.0 | 100.0 |
| and fat + emulsifying | | | | | | |
| material)/emulsion (% by | | | | | | |
| mass) | | | | | | |

(Evaluation of Emulsion Obtained in Preparation Example)

A heat-resistant retort pouch was filled with the emulsion of Preparation Example 21, sealed with a heat seal, and subjected to a pressurized heating treatment at 121° C. for 5 minutes and 121° C. for 30 minutes, and there was no change in the shape under any conditions, while dripping of water or oil was not observed.

Furthermore, a plastic cup with a lid was filled with the emulsion of Preparation Example 3 and stored at 4° C. for 3 days, and there was no change in the shape, while dripping of water or oil was not observed.

### Preparation Examples 22 to 36

An emulsion (composition for food) of each example was prepared according to the formulation shown in Table 10. The mixing method and conditions in each example and the properties of the obtained emulsion (emulsified dough) are shown together in Table 10.

TABLE 10

| | | Preparation | Preparation | Preparation | Preparation | Preparation |
|---|---|---|---|---|---|---|
| | | Example 22 | Example 23 | Example 24 | Example 25 | Example 26 |
| Raw | (A1) Powdery | 50 | 50 | 50 | 50 | 50 |
| material | granular | | | | | |
| (parts by | material 1 | | | | | |
| mass) | Rapeseed oil | 200 | 200 | 300 | 200 | 200 |
| | Casein Na | 10 | 5 | 5 | 5 | 8 |
| | Whey (WPI) | | | | 5 | 2 |
| | Egg yolk | | | | | |
| | Whole egg | | | | | |
| | Skim milk | | | | | |
| | powder | | | | | |
| | Oil and | | | | | |
| | fat-processed | | | | | |
| | starch 1 | | | | | |
| | 42% fresh cream | | | | | |
| | Water | 200 | 200 | 300 | 200 | 200 |
| Mixing method | | Kenmix mixer | Kenmix mixer | Kenmix mixer | Kenmix mixer | Kenmix mixer |
| | | (strength 1 | (strength 1 | (strength 1 | (strength 1 | (strength 1 |
| | | for 7 min) | for 7 min) | for 7 min) | for 7 min) | for 7 min) |
| Form of dough | | Creamy | Creamy | Loose | Pasty | Pasty |
| | | | | cream-like | | |
| State of dough | | 3 | 3 | 3 | 4 | 4 |
| Protein/(A) (% by mass) | | 17.2 | 8.6 | 8.6 | 11.1 | 7.9 |
| Total water portion in | | 43.5 | 44.0 | 45.8 | 43.5 | 43.5 |
| emulsion (% by mass) | | | | | | |
| Total oil portion in | | 43.5 | 44.0 | 45.8 | 43.5 | 43.5 |
| emulsion (% by mass) | | | | | | |
| Oil portion/(A) (mass | | 4.0 | 4.0 | 6.0 | 4.0 | 4.0 |
| ratio) | | | | | | |
| ((A) + water + edible oil | | 100 | 100 | 100 | 100 | 100 |
| and fat + emulsifying | | | | | | |
| material)/emulsion (% | | | | | | |
| by mass) | | | | | | |
| | | Preparation | Preparation | Preparation | Preparation | Preparation |
| | | Example 27 | Example 28 | Example 29 | Example 30 | Example 31 |
| Raw | (A1) Powdery | 50 | 50 | 50 | 50 | 50 |
| material | granular | | | | | |
| (parts by | material 1 | | | | | |
| mass) | Rapeseed oil | 300 | 300 | 91 | 198 | 190 |
| | Casein Na | | | | | |
| | Whey (WPI) | | | | | |
| | Egg yolk | | | | 6 | 30 |
| | Whole egg | | | | | |
| | Skim milk | 15 | 15 | | | |
| | powder | | | | | |
| | Oil and | | 10 | | | |
| | fat-processed | | | | | |
| | starch 1 | | | | | |
| | 42% fresh cream | | | 260 | | |
| | Water | 300 | 300 | 62 | 197 | 186 |
| Mixing method | | Kenmix mixer | Kenmix mixer | Kenmix mixer | Kenmix mixer | Kenmix mixer |
| | | (strength 1 | (strength 1 | (strength 1 | (strength 1 | (strength 1 |
| | | for 7 min) | for 7 min) | for 7 min) | for 7 min) | for 7 min) |
| Form of dough | | Creamy | Creamy | Creamy | Loose | Hard |
| | | | | | cream-like | cream-like |
| State of dough | | 3 | 3 | 4 | 4 | 4 |
| Protein/(A) (% by mass) | | 10.2 | 10.2 | 10 | 2 | 9.9 |
| Total water portion in | | 45.1 | 44.4 | 43.2 | 44.3 | 44.0 |
| emulsion (% by mass) | | | | | | |
| Total oil portion in | | 45.1 | 44.4 | 43.2 | 44.3 | 43.9 |
| emulsion (% by mass) | | | | | | |
| Oil portion/(A) (mass | | 6.0 | 6.0 | 4.0 | 4.0 | 4.0 |
| ratio) | | | | | | |
| ((A) + water + edible oil | | 100 | 100 | 100 | 100.0 | 100.0 |
| and fat + emulsifying | | | | | | |
| material)/emulsion (% | | | | | | |
| by mass) | | | | | | |
| | | Preparation | Preparation | Preparation | Preparation | Preparation |
| | | Example 32 | Example 33 | Example 34 | Example 35 | Example 36 |
| Raw | (A1) Powdery | 50 | 50 | 50 | 50 | 50 |
| material | granular | | | | | |
| (parts by | material 1 | | | | | |
| mass) | Rapeseed oil | 196 | 198 | 199 | 200 | 400 |
| | Casein Na | | | | | |
| | Whey (WPI) | | | | | |
| | Egg yolk | | | | | |
| | Whole egg | 41 | 20 | 10 | 4 | |
| | Skim milk | | | | | 30 |
| | powder | | | | | |
| | Oil and | | | | | |
| | fat-processed | | | | | |
| | starch 1 | | | | | |
| | 42% fresh cream | | | | | |
| | Water | 169 | 185 | 192 | 197 | 250 |

| | | | | | |
|---|---|---|---|---|---|
| Mixing method | Kenmix mixer | Kenmix mixer | Kenmix mixer | Kenmix mixer | Kenmix mixer |
| | (strength 1 | (strength 1 | (strength 1 | (strength 1 | (strength 1 |
| | for 7 min) | for 7 min) | for 7 min) | for 7 min) | for 7 min) |
| Form of dough | Creamy | Creamy | Loose | Loose | Loose |
| | | | cream-like | cream-like | cream-like |
| State of dough | 4 | 4 | 4 | 2 | 3 |
| Protein/(A) (% by mass) | 10.1 | 4.9 | 2.4 | 0.98 | 20.4 |
| Total water portion in | 43.9 | 44.2 | 44.3 | 44.4 | 34.2 |
| emulsion (% by mass) | | | | | |
| Total oil portion in | 43.9 | 44.2 | 44.4 | 44.4 | 54.8 |
| emulsion (% by mass) | | | | | |
| Oil portion/(A) (mass | 4.0 | 4.0 | 4.0 | 4.0 | 8.0 |
| ratio) | | | | | |
| ((A) + water + edible oil | 100.0 | 100.0 | 100.0 | 100.0 | 100.0 |
| and fat + emulsifying | | | | | |
| material)/emulsion (% | | | | | |
| by mass) | | | | | |

### Preparation Example 37

An emulsion (composition for food) of the present example was prepared according to the formulation described in Table 11. The mixing method and conditions in the present example and the properties of the obtained emulsion (emulsified dough) are shown together in Table 11.

Here, with regard to the state of the dough, evaluation was carried out according to the methods in the above-mentioned Preparation Examples. Furthermore, in the present example, the heated retention properties of the emulsion were evaluated by the following procedure.

(Heated Retention Properties)

About 65 g of the obtained emulsion was scooped up with an ice cream disher and placed in an aluminum cup. The emulsion together with the aluminum cup was placed in a convection oven heated to 200° C., heated for 5 minutes, and then taken out from the convection oven, and the state of the dough was immediately evaluated by visual inspection.

TABLE 11

| | | Preparation Example |
|---|---|---|
| | | 37 |
| Raw | (A1) Powdery granular | 10 |
| material | material 1 | |
| (parts | Rapeseed oil | 40 |
| by mass) | Pea protein | 3 |
| | Water | 40 |

| | |
|---|---|
| Mixing method | Kenmix mixer |
| | (strength 1 for 7 min) |
| Form of dough | Semisolid form |
| State of dough | 4 |
| Heated retention properties | Soft but form is not |
| | disintegrated. |
| | Surface is smooth, |
| | and Shape |
| | retainability is |
| | highly satisfactory |
| Protein/(A) (% by mass) | 25.5 |
| Total water portion in emulsion (% by | 43.0 |
| mass) | |
| Total oil portion in emulsion (% by mass ) | 43.2 |
| Oil portion/(A) (mass ratio) | 4.0 |
| ((A) + water + edible oil and fat + | 100 |
| emulsifying material)/emulsion (% by | |
| mass) | |

*Remark) Component (A) was calculated to have a solid content of 100% (water fraction value 0)

(Production Example of Composition for Food)

In a Kenmix Mixer, 20 parts of pork (15 parts of fat: 5 parts of lean meat) obtained by adding 5 parts of the component (A) and salt in an amount of 2% with respect to the meat and mixing the mixture for 30 seconds with a tabletop cutter mixer until a paste form was obtained, and 15 parts of water were thoroughly mixed, and the mixture was mixed while stirred in a Kenmix Mixer to obtain an emulsion of the present example.

### Example 13

In the present example, production and evaluation of a Negitoro (minced tuna)-like food were carried out by using a composition for food formed from an emulsion.

(Preparation of Negitoro-Like Food)

1. An emulsion was obtained by the same method as in Example 8, except that olive oil in the formulation of the emulsion of Example 8 (formulation of “Emulsion (composition for food)” in Table 4) was replaced with rapeseed oil.

2. 50 g of tuna (medium fatty tuna) was finely divided with a food processor, and 0.037 g of stock granules (Hondashi (registered trademark) manufactured by Ajinomoto Co., Inc.) was added thereto and mixed.

3. 15 g of the emulsion of the item 1. was added to the tuna of the item 2., and the mixture was mixed by hand to obtain a Negitoro-like food.

4. Soy sauce was added to the Negitoro-like food, and a sensory evaluation was performed. As a control, Negitoro obtained without performing the procedure of the item 3. was used.

As a result of the sensory evaluation, the Negitoro-like food obtained in Example 13 had a preferable texture without a discomfort feeling as compared with the Negitoro (control) containing only tuna, and had a satisfactory flavor with a fattier feeling of fish than the control.

### Example 14

In the present example, production and evaluation of a hanpen-like water-kneaded food were carried out by using an emulsion.

(Preparation of Hanpen-Like Water-Kneaded Food)

1. All the raw ingredients described in Table 12 were introduced into a food processor (manufactured by Cuisinart Corporation) and mixed for 8 minutes, and a surimi for a hanpen-like water-kneaded food was obtained.

2. The surimi of the item 1. and the emulsion of Preparation Example 7 were thoroughly mixed at a proportion of 7:3 (mass ratio) in a bowl with a rubber spatula.

3. The product obtained in the item 2. was put into a Satsuma-age mold, the amount of each piece of the product being 100 g, and was shaped. In addition, as a control example, the surimi of the item 1. was put into a mold as it was, the amount of each piece of the surimi being 100 g, and was shaped.

4. The surimi pieces obtained in the item 3. were taken out of the mold, placed one by one on cooking paper, and heated in a steam oven at 90° C. under the conditions of 100% steam and 25 minutes.

5. The cooked products were left to stand to cool to room temperature, and Hanpen-like water-kneaded food of each example was obtained.

TABLE 12

| Raw ingredient | (parts by mass) |
|---|---|
| Alaskapollack | 336.0 |
| surimi | |
| Potato starch | 24.5 |
| Sugar | 14.7 |
| Soybean protein | 14.0 |
| Table salt | 10.5 |
| Sake | 7.0 |
| Instant bouillon | 1.8 |
| Na glutamate | 7.0 |
| K sorbate | 0.7 |
| Water | 252.0 |
| Total | 668.2 |

(Raw Ingredients)

The details of the raw ingredients described in Table 12 are as follows.

Alaska pollack surimi: Alaska pollack surimi (product of the United States), purchased from Tokai Denpun Co., Ltd.

Potato starch: BP-200, manufactured by J-Oil Mills, Inc.

Soybean protein: New Fuji Pro SEH, manufactured by Fuji Oil Co., Ltd.

Instant bouillon: Instant bouillon, manufactured by Yamaki Co., Ltd.

Na glutamate: AJINOMOTO (registered trademark), manufactured by Ajinomoto Co., Inc.

K sorbate: Manufactured by Kurimoto Pharmaceutical Industries Corporation

When the obtained Hanpen-like water-kneaded food of Example 14 was eaten, it had a fluffy and preferable texture similar to Hanpen. On the other hand, the Control Example had a soft kamaboko-like texture, and no fluffy feeling like hanpen was felt.

By adding the emulsion of the present Example, a water-kneaded food having a hanpen-like texture was obtained, even though materials such as egg white and yam were not added.

### Examples 15 to 17 and Control Example 3

In the present examples, production and evaluation of chicken sausage were carried out by using an emulsion.

(Preparation of Chicken Sausage)

1. Chicken breast meat was cut into cubes measuring 1 to 2 cm on each side and was introduced into a food processor (manufactured by Cuisinart Corporation) together with the ingredients of (1) in Table 13, and the components were mixed for 4 minutes.

2. In Examples 15 to 17, the ingredients of (2) in Table 13 were mixed to produce an emulsion, which was added to the above-described item 1, and the mixture was mixed with a spatula so as to be uniform.

3. In Control Example 3, a dough obtained in the item 1. was placed in a zipper-type bag, and degassing was performed with a vacuum packaging machine (manufactured by Nichiwa Electric Corporation, Hot Temp). In Examples 15 to 17, a dough obtained in the item 2. was degassed in the same manner.

4. Collagen casings (manufactured by Nippi, Inc.) were filled with the item 3. by using a sausage maker (manufactured by Shinfuji Burner Co., Ltd., Sausage Maker).

5. The obtained sausages were placed in a convection oven and air-dried at 50° C. for 30 minutes.

6. The sausages were boiled in hot water at 75° C. to 80° C. for 30 minutes and then cooled under flowing water for 10 minutes.

7. The sausages were heated in a 700-W microwave oven for 20 seconds were eaten, and an evaluation of the texture was performed.

The results of evaluating the texture (moist feeling) by eating Control Example 3 and Examples 15 to 17 are shown in Table 13. One specialized panelist performed the evaluation on a four-point scale according to the following criteria, and a score of equal to or higher than 2 points was considered acceptable.

4: Very moist

3: There is no dryness, and it is moist

2: There is some dryness, and there is a moist feeling

1: Dry

TABLE 13

| | | | Control | | | |
|---|---|---|---|---|---|---|
| | | | Example 3 | Example 15 | Example 16 | Example 17 |
| Formulation | (1) Chicken breast meat | | 53.0 | 53.0 | 53.0 | 53.0 |
| (unit: parts) | (1) Reduced starch syrup | | 2.0 | 2.0 | 2.0 | 2.0 |
| | (1) Tripolyphosphate | | 0.8 | 0.8 | 0.8 | 0.8 |
| | (1) Table salt | | 2.2 | 2.2 | 2.2 | 2.2 |
| | (1) Water | | 24.0 | 24.4 | 24.0 | 24.0 |
| | (1) Wiener spice | | 0.7 | 0.7 | 0.7 | 0.7 |
| | (1) Vitamin C | | 0.2 | 0.2 | 0.2 | 0.2 |
| | (1) Rapeseed oil | | 8.0 | 10.0 | 8.0 | 8.0 |
| | (1) Shortening | | 4.0 | 2.0 | 4.0 | 4.0 |
| | (1) Powdered soybean protein | | 1.5 | 2.0 | 1.5 | 1.5 |
| | (1) Powdered egg white | | 1.0 | 0.5 | 1.0 | 1.0 |
| | (1) Skim milk powder | | 0.6 | 0.2 | | |
| | (1) Potato starch | | 2.0 | 2.0 | | |
| | (1) Oil and fat-processed starch 1 | | | | 2.0 | 2.0 |
| | Emulsion | (2) (A1) Powdery | | 1.0 | 1.0 | 1.0 |
| | (composition for | granular material 1 | | | | |
| | food) | (2) Skim milk powder | | 0.6 | 0.6 | 0.6 |
| | | (2) Rapeseed oil | | 4.0 | 4.0 | |
| | | (2) Shortening | | | | 4.0 |
| | | (2) Water | | 4.0 | 4.0 | 4.0 |

| | | | | |
|---|---|---|---|---|
| Total | 100.0 | 109.6 | 109.0 | 109.0 |

| | | | | |
|---|---|---|---|---|
| Protein/(A) (% by mass) | — | 20.4 | 20.4 | 20.4 |
| Total water portion in emulsion (% by mass) | — | 41.7 | 41.7 | 41.7 |
| Total oil portion in emulsion (% by mass) | — | 41.7 | 41.7 | 41.7 |
| Oil portion/(A) (mass ratio) | — | 4.006 | 4.006 | 4.002 |
| ((A) + water + edible oil and fat + emulsifying material)/ | — | 100.0 | 100.0 | 100.0 |
| emulsion (% by mass) | | | | |
| Evaluation of texture (moist feeling) | 1 | 2 | 3 | 4 |

*Remark) Component (A) and skim milk powder were calculated to have a solid content of 100% (water fraction value 0).

Details of the raw ingredients described in Table 13 are described below.

(Edible Oil and Fat in Emulsion)

Rapeseed oil: “AJINOMOTO Sara-sara Canola Oil”, manufactured by J-Oil Mills, Inc., solid fat content at 20° C. 0%

Shortening: “S Special”, manufactured by J-Oil Mills, Inc. (lipid content 99.9% by mass, water portion 0.1% by mass), solid fat content at 20° C. 5.5%

(Emulsifying Material or Ingredient Including Emulsifying material in emulsion)

Dried egg white: Dried Egg White W type, manufactured by Zen-noh Kewpie Egg-Station Co., Ltd.

Skim milk powder: Skim Milk Powder, manufactured by Yotsuba Milk Products Co., Ltd. (protein content 34.0% by mass, lipid content 1.0% by mass)

(Other Ingredients)

Reduced starch syrup: “Marby”, manufactured by H Plus B Life Science Co., Ltd.

Tripolyphosphate: Sodium tripolyphosphate, manufactured by Mitejima Chemical Co., Ltd.

Wiener Spice: Imported and sold by Hera Spice Japan Co., Ltd.

Vitamin C: Sodium L-ascorbate, manufactured by Happo Shokusan Co., Ltd.

Powdered soybean protein: New Fuji Pro SEH, manufactured by Fuji Oil Co., Ltd.

Potato starch: Gelcol BP-200, manufactured by J-Oil Mills, Inc.

Oil and fat-processed starch 1: Oil and fat-processed starch obtained in Production Example 4

From Table 13, all of Examples 15 to 17 had less dryness as compared with Control Example 3 and had a moist and preferable texture.

### Preparation Examples 38 and 39, Control Example 4, and Examples 18 to 25

In the present examples, production and evaluation of a kamaboko (boiled fish-paste)-like food (hereinafter, described as “kamaboko”) were carried out by using a composition for food formed from an emulsion.

(Production Example of Composition for Food)

The ingredients described in Table 14 were used according to the formulations in the same table, and compositions for food of Preparation Examples 38 and 39 were obtained by the following procedure.

### Preparation Procedure of Preparation Example 38

Powdery granular material 1, dried egg white, and oil and fat-processed starch 1 were added to rapeseed oil and mixed. In addition, the mixture was mixed while adding water, and an emulsion was obtained.

### Preparation Procedure of Preparation Example 39

1. Solid fat (pure lard), powdery granular material 1, and oil and fat-processed starch 1 were introduced into a food processor (manufactured by Cuisinart Corporation) and mixed.

2. In addition, the mixture was mixed while adding water, and an emulsion was obtained.

By using the composition for food formed from the emulsion obtained in Preparation Example 38 and the ingredients described in Table 15 according to the formulations described in the same table, kamaboko of Examples 18 to 21 and Control Example 4 was produced by the following procedure.

### Production Methods of Examples 18 to 21 and Control Example 4

1. Surimi of frozen Alaska pollack was cut and finely crushed with a food processor (manufactured by Cuisinart Corporation).

2. Table salt was added to the surimi of the item 1., and ice in a one-third amount was added thereto and mixed.

3. Sugar, Na glutamate, egg white, stock granules, oil and fat-processed starch, and ice in a one-third amount were added thereto and mixed, and then all the remaining amount of ice was added thereto and mixed. In Examples 18 to 21, the emulsion was further added thereto and mixed.

4. The mixture obtained in the item 3. was put in a plastic bag and degassed with a vacuum packaging machine (Hot Temp, manufactured by Nichiwa Electric Corporation).

5. Vinyl casings were filled with the mixture, and then a sitting treatment was performed at 30° C. for 90 minutes.

6. Heating in a water bath was performed at 90° C. for 20 minutes, and then the resultant was put into ice water and cooled for 10 minutes.

7. Kamaboko of each example produced by the above-described procedure was stored in refrigeration (4° C.) for 1 day and 7 days, and then evaluation of the respective items of external appearance, hardness, and elasticity was carried out. With regard to hardness and elasticity, measurement with a texture analyzer was also carried out in addition to sensory evaluation.

Kamaboko of Examples 22 to 25 was produced by the following procedure by using a composition for food formed from the emulsion obtained in Preparation Example 39 and the ingredients described in Table 15 according to the formulations described in the same table.

### Production Method of Examples 22 to 25

1. Surimi of frozen Alaska pollack was cut, and the surimi was crushed and mixed together with Preparation Example 39 with a food processor (manufactured by Cuisinart Corporation).

2. Table salt was added to the mixture of the item 1., and ice in a one-third amount was added thereto and mixed.

3. Sugar, Na glutamate, egg white, stock granules, oil and fat-processed starch, and ice in a one-third amount were added thereto and mixed, and then all the remaining amount of ice was added thereto and mixed.

4. The production process and various evaluations after degassing were carried out by the same procedure and methods as in Examples 18 to 21.

(Evaluation Methods)

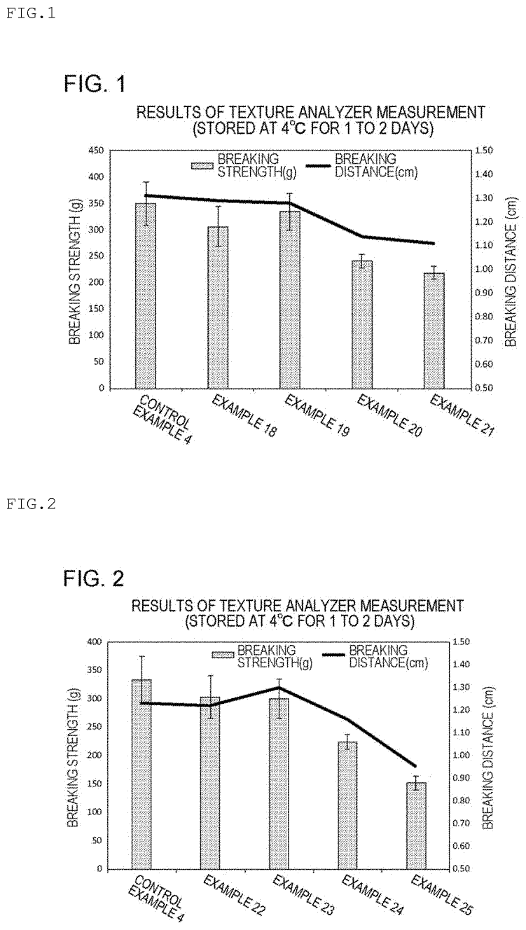

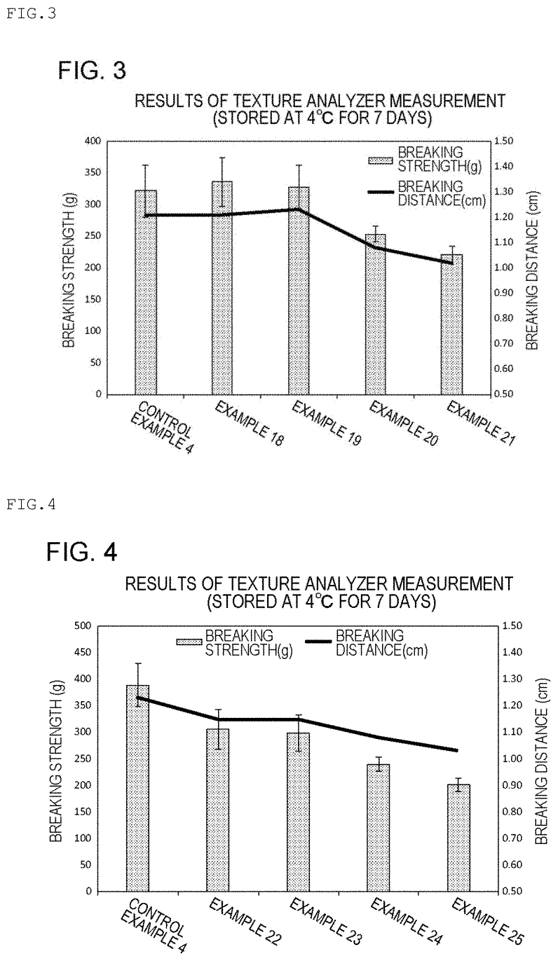

The sensory evaluation of hardness and elasticity was carried out by one specialized panelist, and evaluation was performed on a three-point scale shown below on the basis of Control Example 4 in which a composition for food formed from the emulsion was not blended. For each evaluation item, a score of equal to or higher than 2 points was considered acceptable. In the measurement of the texture analyzer, breaking strength (hardness) and breaking distance (elasticity) were measured by the following methods. The results of the sensory evaluation are shown in Table 15, and the results of the texture analyzer measurement are shown in Table 16, Table 17, and FIG. 1 to FIG. 4.

(Hardness)

3 points: Having hardness equivalent to that of Control Example 4

2 points: A little softer than Control Example 4

1 point: Much softer than Control Example 4

(Elasticity)

3 points: Having elasticity equivalent to that of Control Example 4

2 points: Having a little weaker elasticity than Control Example 4

1 point: Less elastic than Control Example 4

(Measurement Using Texture Analyzer)

In a state in which the casing was peeled off from the kamaboko, the kamaboko was cut into a cylindrical shape with a diameter of 30 mm and a thickness of 25 mm, and this was used as a measurement sample. A sample was placed on a sample stage, with the flat surfaces facing up and down, the sample was penetrated through by 15 mm at the central part from the sample upper surface at a compression rate of 1 mm/sec at room temperature (about 20° C.) with a texture analyzer (TA-XT Plus, manufactured by Stable Micro Systems, Ltd.) equipped with a ball-shaped probe having a diameter of 5 mm, and the breaking strength (g) and the breaking distance (mm) were measured. The breaking strength was used as an index showing the hardness of the measurement sample, and the breaking distance was used as an index showing the elasticity of the measurement sample.

Each example was tested four times, and the average value was used as the result.

TABLE 14

| | | Preparation | Preparation |
|---|---|---|---|
| | | Example 38 | Example 39 |
| Formulation | (A1) Powdery granular | 1.0 | 1.0 |
| (unit: parts | material 1 | | |
| by mass) | Dried egg white | 0.3 | |
| | Rapeseed oil | 4.0 | |
| | Lard | | 2.0 |
| | Water | 4.0 | 4.0 |
| | Oil and fat-processed starch 1 | 1.0 | 0.3 |

| | | |
|---|---|---|
| Mixing method | Hand mixing | Food processor |
| Properties of dough | Pasty | Whipped |
| | | cream-like |
| Protein/(A) (% by mass) | 26.0 | 0.0 |
| Total water portion in emulsion ( % by mass ) | 38.8 | 54.8 |
| Total oil portion in emulsion (% by mass) | 38.9 | 27.4 |
| Oil portion/(A) (mass ratio) | 4.002 | 2.000 |
| ((A) + water + edible oil and fat + | 100.0 | 100.0 |
| emulsifying material)/emulsion (% by | | |
| mass) | | |

*Remark) Component (A) and dried egg white were calculated to have a solid content of 100% (water fraction value 0).

TABLE 15

| | | | Control | | | | |
|---|---|---|---|---|---|---|---|
| | | | Example 4 | Example 18 | Example 19 | Example 20 | Example 21 |
| Formulation | Alaska pollack surimi | | 50.0 | 47.0 | 45.0 | 40.0 | 35.0 |
| (unit: | Table salt | | 1.5 | 1.5 | 1.5 | 1.5 | 1.5 |
| parts by | Sugar | | 2.0 | 2.0 | 2.0 | 2.0 | 2.0 |
| mass) | Na glutamate | | 1.0 | 1.0 | 1.0 | 1.0 | 1.0 |
| | Egg white | | 2.0 | 2.0 | 2.0 | 2.0 | 2.0 |
| | Stock granules | | 0.5 | 0.5 | 0.5 | 0.5 | 0.5 |
| | Oil and fat-processed starch 1 | | 4.0 | 4.0 | 4.0 | 4.0 | 4.0 |
| | Ice | | 39.0 | 39.0 | 39.0 | 39.0 | 39.0 |
| | Emulsion | Preparation | | 3.0 | 5.0 | 10.0 | 15.0 |
| | (composition for | Example 38 | | | | | |
| | food) | Preparation | | | | | |
| | | Example 39 | | | | | |

| | | | | | |
|---|---|---|---|---|---|
| Total | 100.0 | 100.0 | 100.0 | 100.0 | 100.0 |

| | | | | | |
|---|---|---|---|---|---|
| External appearance | — | Equivalent | Equivalent | Equivalent | Equivalent |
| | | to | to | to | to |
| | | Comparative | Comparative | Comparative | Comparative |
| | | Example 4 | Example 4 | Example 4 | Example 4 |
| Hardness (sensory evaluation), day 1 under | — | 3 | 3 | 2 | 2 |
| refrigerated storage | | | | | |
| Hardness (sensory evaluation), day 7 under | — | 3 | 3 | 2 | 2 |
| refrigerated storage | | | | | |
| Elasticity (sensory evaluation), day 1 under | — | 3 | 3 | 2 | 2 |
| refrigerated storage | | | | | |
| Elasticity (sensory evaluation), day 7 under | — | 3 | 3 | 2 | 2 |
| refrigerated storage | | | | | |

| | | Example 22 | Example 23 | Example 24 | Example 25 |
|---|---|---|---|---|---|
| Formulation | Alaska pollack surimi | 47.0 | 45.0 | 40.0 | 35.0 |
| (unit: | Table salt | 1.5 | 1.5 | 1.5 | 1.5 |
| parts by | Sugar | 2.0 | 2.0 | 2.0 | 2.0 |
| mass) | Na glutamate | 1.0 | 1.0 | 1.0 | 1.0 |
| | Egg white | 2.0 | 2.0 | 2.0 | 2.0 |
| | Stock granules | 0.5 | 0.5 | 0.5 | 0.5 |
| | Oil and fat-processed starch 1 | 4.0 | 4.0 | 4.0 | 4.0 |
| | Ice | 39.0 | 39.0 | 39.0 | 39.0 |

| | | | | | |
|---|---|---|---|---|---|
| Emulsion | Preparation | | | | |
| (composition for | Example 38 | | | | |
| food) | Preparation | 3.0 | 5.0 | 10.0 | 15.0 |
| | Example 39 | | | | |

| | | | | |
|---|---|---|---|---|
| Total | 100.0 | 100.0 | 100.0 | 100.0 |

| | | | | |
|---|---|---|---|---|
| External appearance | Equivalent | Equivalent | Equivalent | Equivalent |
| | to | to | to | to |
| | Comparative | Comparative | Comparative | Comparative |
| | Example 4 | Example 4 | Example 4 | Example 4 |
| Hardness (sensory evaluation), day 1 under | 3 | 3 | 2 | 2 |
| refrigerated storage | | | | |
| Hardness (sensory evaluation), day 7 under | 3 | 3 | 2 | 2 |
| refrigerated storage | | | | |
| Elasticity (sensory evaluation), day 1 under | 3 | 3 | 2 | 2 |
| refrigerated storage | | | | |
| Elasticity (sensory evaluation), day 7 under | 3 | 3 | 2 | 2 |
| refrigerated storage | | | | |

Details of the raw ingredients described in Table 14 are described below.

Rapeseed oil: “AJINOMOTO Sara-sara Canola Oil”, manufactured by J-Oil Mills, Inc.

Lard: Pure lard, Nice Lard P preparation, manufactured by Ueda Oils & Fats Manufacturing Co., Ltd.

Dried egg white: Dried Egg White W type, manufactured by Zen-noh Kewpie Egg-Station Co., Ltd.

Oil and fat-processed starch 1: Oil and fat-processed starch obtained in Production Example 4 (protein content 0% by mass, lipid content 0.1% by mass)

Details of the raw ingredients described in Table 15 are described below.

Na glutamate: “AJINOMOTO” (registered trademark), manufactured by Ajinomoto Co., Inc.

Stock granules: Instant bouillon, manufactured by Yamaki Co., Ltd.

Oil and fat-processed starch 1: Oil and fat-processed starch obtained in Production Example 4 (protein content 0% by mass, lipid content 0.1% by mass)

TABLE 16

| | Sample storage | | Control | | | | |
|---|---|---|---|---|---|---|---|
| | condition | | Example 4 | Example 18 | Example 19 | Example 20 | Example 21 |
| Breaking | 4° C., for 1 to 2 | Average | 350.05 | 306.69 | 334.51 | 241.56 | 219.14 |
| strength (g) | days | (S.D.) | (40.66) | (37.55) | (34.46) | (12.88) | (12.76) |
| | 4° C., for 7 days | Average | 321.48 | 335.61 | 327.05 | 253.49 | 220.93 |
| | | (S.D.) | (49.51) | (38.43) | (34.09) | (14.92) | (8.5) |
| Breaking | 4° C., for 1 to 2 | Average | 1.31 | 1.29 | 1.28 | 1.14 | 1.11 |
| distance (cm) | days | (S.D.) | (0.1) | (0.12) | (0.07) | (0.04) | (0.04) |
| | 4° C., for 7 days | Average | 1.21 | 1.21 | 1.23 | 1.08 | 1.02 |
| | | (S.D.) | (0.09) | (0.05) | (0.03) | (0.02) | (0.02) |

TABLE 17

| | Sample storage | | Control | | | | |
|---|---|---|---|---|---|---|---|
| | condition | | Example 4 | Example 22 | Example 23 | Example 24 | Example 25 |
| Breaking | 4° C., for 1 to 2 | Average | 333.82 | 302.86 | 299.91 | 224.41 | 151.51 |
| strength (g) | days | (S.D.) | (28.55) | (21.87) | (32.68) | (13.8) | (9.8) |
| | 4° C., for 7 days | Average | 388.7 | 305.17 | 298.77 | 239.81 | 201.51 |
| | | (S.D.) | (16.57) | (24.56) | (53.86) | (22.77) | (44.04) |
| Breaking | 4° C., for 1 to 2 | Average | 1.23 | 1.22 | 1.3 | 1.16 | 0.95 |
| distance (cm) | days | (S.D.) | (0.05) | (0.05) | (0.09) | (0.04) | (0.04) |
| | 4° C., for 7 days | Average | 1.23 | 1.15 | 1.15 | 1.08 | 1.03 |
| | | (S.D.) | (0.02) | (0.05) | (0.12) | (0.05) | (0.17) |

The kamaboko obtained in Examples 18 to 25 had both elasticity and hardness and also had a texture that could be eaten without a discomfort feeling as kamaboko. In addition, as shown by the results of the sensory evaluation in Table 15 and the results of texture analyzer measurement in Table 16, Table 17, and FIG. 1 to FIG. 4, Examples 18, 19, 22, and 23 had hardness and elasticity equivalent to those of Control Example 4 (3 points in the sensory evaluation) and also had a good texture. Furthermore, the external appearance such as smoothness of appearance was equivalent to that of Control Example 4 in all of Examples 18 to 25.

### Example 26

In the present example, production and evaluation of a non-fried potato snack were carried out by using the emulsion. Information on ingredients and formulation is shown in Table 18.

(Production Procedure for Non-Fried Potato Snack)

1. Powdery granular material 1 and skim milk powder were stirred in rapeseed oil, water was further added thereto, and the mixture was mixed by hand to obtain an emulsion.

2. Dried potatoes, salt, and a little bit of white pepper were mixed.

3. The emulsion obtained in Procedure 1. was added thereto and mixed.

4. The mixture was shaped into a single bite-sized round shape by hand, and the shaped pieces were lined up on an iron plate.

5. The pieces were baked in an oven at 200° C. for 4.5 minutes.

TABLE 18

| | | | Example 26 |
|---|---|---|---|
| Formulation | Dried potato | | 24.8 |
| (unit: parts) | Salt | | 1.0 |
| | White pepper | | 0.0 |
| | Emulsion | (A1) Powdery granular | 8.0 |
| | | material 1 | |
| | (composition for food) | Skim milk powder | 2.4 |
| | | Rapeseed oil | 24.0 |
| | | Water | 39.9 |

| | |
|---|---|
| Total | 100.0 |

| | |
|---|---|
| Protein/(A) (% by mass) | 10.2 |
| Total water portion in emulsion (% by mass) | 53.8 |
| Total oil portion in emulsion (% by mass) | 32.3 |
| Oil portion/(A) (mass ratio) | 3.0 |
| ( (A) + water + edible oil and fat + | 100.0 |
| emulsifying material)/emulsion (% by mass) | |

Details of the ingredients described in Table 18 are described below.

Rapeseed oil: “AJINOMOTO Sara-sara Canola Oil”, manufactured by J-Oil Mills, Inc.

Skim milk powder: Skim milk powder, manufactured by Hokkaido Dairy Products Co., Ltd. (protein content 34.0% by mass, lipid content 1.0% by mass)

Dried potato: Commercial potato flakes, manufactured by Hinokuni Food Industry Co., Ltd.

As a result of the present Example, a light-tasting potato snack having a crispy texture like a fried snack confectionery and having no oiliness, was obtained. Furthermore, this texture was maintained even when the above-described snack was cooled at room temperature for 1 hour and then eaten.

### Example 27

In the present example, a potato baking-cooked food was produced by using a composition for food formed from the emulsion as a batter liquid.

(Potato Baking-Cooked Food)

1. Potatoes diced into slender sticks were boiled in salt water for 1 minute, subsequently cooled in cold water, and drained well.

2. The components described in Table 19 were used according to the formulation shown in the same table, and a batter liquid was produced. Specifically, to an emulsion obtained by mixing powdery granular material 1, dried egg white, and rapeseed oil, and further mixing water therein, salt and a little bit of white pepper were added, and the mixture was thoroughly mixed.

3. The potatoes prepared by procedure 1. were dusted with potato starch, and the batter liquid obtained by procedure 2. was attached thereto.

4. The potatoes were baked in an oven at 200° C. for 10 minutes.

TABLE 19

| | | | Example 27 |
|---|---|---|---|
| Formulation | Salt | | 0.9 |
| (unit: | White pepper | | 0.0 |
| parts) | Emulsion | (A1) Powdery granular | 10.7 |
| | | material 1 | |
| | (composition for | Dried egg white | 3.2 |
| | food) | Rapeseed oil | 21.3 |
| | | Water | 64.0 |

| | |
|---|---|
| Total | 100.0 |

| | |
|---|---|
| Protein/(A) (% by mass) | 26.0 |
| Total water portion in emulsion (% by mass) | 64.5 |
| Total oil portion in emulsion (% by mass) | 21.5 |
| Oil portion/(A) (mass ratio) | 2.0 |
| ((A) + water + edible oil and fat + | 100.0 |
| emulsifying material)/emulsion (% by mass) | |

Details of the ingredients described in Table 19 are as follows.

Rapeseed oil: “AJINOMOTO Sara-sara Canola Oil”, manufactured by J-Oil Mills, Inc.

Dried egg white: Dried Egg White W type, manufactured by Zen-noh Kewpie Egg-Station Co., Ltd. (protein content 86.5% by mass, lipid content 0.4% by mass)

From the present example, a French fries-like potato baking-cooked food having a batter coating that was not greasy and had a crispy and satisfactory texture was obtained. Furthermore, even when the food was eaten after being left to stand at room temperature for 1 hour, the crispy feeling of the batter coating was maintained.

### Preparation Examples 40 to 43

An emulsion (composition for food) of each example was prepared according to the formulation shown in Table 20. The preparation method is described below.

(Preparation Procedure for Emulsion)

1. The ingredients of (1) and the ingredients of (2) in Table 20 were respectively separately mixed.

2. The mixture of the ingredients of (2) was added to the mixture of the ingredients of (1), and the mixture was stirred with a Kenmix mixer (strength 2) for 3 minutes.

3. While the ingredients of (3) were added, the mixture was stirred with a Kenmix mixer (strength 3) for 7 minutes, and an emulsion was obtained.

(Evaluation of Emulsion)

The properties of the obtained emulsion (composition for food), the heating yield, and the evaluation results for heating shape retainability are shown together in Table 20. The retention during heating was measured and calculated by the same method as in Preparation Examples 1 to 21. Furthermore, with regard to the heating shape retainability, one worker performed evaluation by visually observing the external appearance of the emulsion immediately after the baking carried out at the time of measuring the heating yield.

TABLE 20

| | | Preparation | Preparation | Preparation | Preparation |
|---|---|---|---|---|---|
| | | Example 40 | Example 41 | Example 42 | Example 43 |
| Formulation | (1)(A1) Powdery | 25.0 | 25.0 | 25.0 | 25.0 |
| (unit: g) | granular material 1 | | | | |
| | (1) Dried egg white | 10.0 | 10.0 | 10.0 | 10.0 |
| | (1) Rapeseed oil | 125.0 | 125.0 | 125.0 | 125.0 |
| | (2) Water | 125.0 | 150.0 | 200.0 | 200.0 |
| | (2) Table salt | 8.0 | 8.0 | 8.0 | 8.0 |
| | (3) Rapeseed oil | 1025.0 | 1125.0 | 1375.0 | 2375.0 |

| | | | | |
|---|---|---|---|---|
| Protein/(A) (% by mass) | 0.3 | 0.3 | 0.3 | 0.3 |
| Total water portion in emulsion | 9.5 | 10.4 | 11.5 | 7.3 |
| (% by mass) | | | | |
| Total oil portion in emulsion (% | 87.3 | 86.6 | 86.1 | 91.1 |
| by mass) | | | | |
| Oil portion/(A) (mass ratio) | 46.00 | 50.00 | 60.00 | 100.00 |
| ((A) + water + edible oil and fat | 99.4 | 99.4 | 99.5 | 99.7 |
| + emulsifying material)/ | | | | |
| emulsion (% by mass) | | | | |
| Properties of emulsion | Pasty | Semisolid | Fairly loose | Pasty |
| | | form | paste-like | |
| Before baking (g) | 48.9 | 51.4 | 52.4 | 54.6 |
| After baking (g) | 48.0 | 50.7 | 50.3 | 54.1 |
| Heating yield (%) | 98.3 | 98.6 | 96.1 | 99.1 |
| Heating shape retainability | Have heating | Have heating | Have heating | Have heating |
| | shape | shape | shape | shape |
| | retainability | retainability | retainability | retainability |

*Remark) Component (A) and dried egg white were calculated to have a solid content of 100% (water fraction value 0).

Details of the ingredients shown in Table 20 are described below.

Rapeseed oil: “AJINOMOTO Sara-sara Canola Oil”, manufactured by J-Oil Mills, Inc.

Dried egg white: “Orlan-A10”, manufactured by Organo Food Tech Corporation (protein content 86.5% by mass, lipid content 0.4% by mass)

As shown in Table 20, all of the emulsions obtained in Preparation Examples 40 to 43 had a satisfactory heating yield and heating shape retainability.

### Example 28 and Control Examples 5 and 6

In the present example, a pickling liquid was produced by using the emulsion, and production of a salmon steak using salmon fillets injected with the emulsion and evaluation thereof were carried out.

(Preparation of Pickling Liquid)

The ingredients shown in Table 21 were used according to the formulation of the same table to prepare a pickling liquid. In the Control Example, all the ingredients were mixed to obtain a pickling liquid. In Example 28, a pickling liquid was prepared by a procedure similar to that of Preparation Examples 40 to 43.

Information on the ingredients used for the emulsion is shown below in Table 21.

Rapeseed oil: “AJINOMOTO Sara-sara Canola Oil”, manufactured by J-Oil Mills, Inc.

Dried egg white: “Orlan-A10”, manufactured by Organo Food Tech Corporation

TABLE 21

| | | Control | Control | |
|---|---|---|---|---|
| | | Example | Example | Example |
| | | 5 | 6 | 28 |
| Formulation | (1) (A1) Powdery | | | 3.0 |
| | granular material 4 | | | |
| (unit: parts) | (1) Dried egg white | | 1.3 | 1.3 |
| | (1) Rapeseed oil | | 15.0 | 15.0 |
| | (2) Water | 98.8 | 32.5 | 29.5 |
| | (2) Table salt | 1.0 | 1.0 | 1.0 |
| | (2) Black pepper | 0.2 | 0.2 | 0.2 |
| | (3) Rapeseed oil | | 50.0 | 50.0 |
| | Total | 100.0 | 100.0 | 100.0 |

| | | | |
|---|---|---|---|
| Protein/(A) (% by mass) | — | — | 0.4 |
| Total water portion in emulsion (% by mass) | — | — | 14.8 |
| Total oil portion in emulsion (% by mass) | — | — | 57.5 |
| Oil portion/(A) (mass ratio) | — | — | 38.34 |
| ( (A) + water + edible oil and fat + | — | — | 74.4 |
| emulsifying material)/emulsion (% by mass) | | | |

*Remark) Component (A) and dried egg white were calculated to have a solid content of 100% (water fraction value 0).

(Production Procedure for Salmon Steak)

1. By using an injector (manufactured by Tohnichi Manufacturing Co., Ltd., Super Injector TN-SP18) for salmon fillets, injection into a salmon fillet was performed two times each on the front and back sides (skin surface, fillet surface) of the fillet. The standard injection amount was set to 10% with respect to the fish meat.

2. The fillet after injection was placed in a rotary tumbler (manufactured by Ohmichi Co., Ltd.), air was suctioned up to 600 mmHg, and tumbling was performed at 12 rpm and 10° C. for 60 minutes.

3. A batter liquid was produced by suspending an oil and fat-processed starch HB-150 (manufactured by J-Oil Mills, Inc.) in cold water at a mass ratio of 1.9 times.

4. The batter liquid obtained in procedure 4. and bread crumbs (manufactured by Kyoei Food Co., Ltd.) were applied on the salmon fillet that had been subjected to a tumbling treatment by procedure 3., and the salmon fillet was fried in vegetable oil at about 170° C. for 3.5 minutes to produce a salmon steak. After cooling at normal temperature for about 30 minutes, the salmon steak was eaten, and a sensory evaluation was performed.

(Evaluation of Feeling of Fatty Meat)

One specialized panelist ate the salmon steak obtained in each example and performed a sensory evaluation of a feeling of fatty meat according to the evaluation criteria described below. The results are shown in Table 22.

3 points: There is a feeling of fatty meat, and the meat quality is moist.

2 points: A weak feeling of fatty meat is felt, and the meat quality is slightly moist.

1 point: There is no feeling of fatty meat, and the meat quality is dry.

(Calculation of Yield)

The weight of the cooked product produced by using the pickling liquid of each example was measured in each cooking step, and the product yield was calculated by using the following formula. The results are shown in Table 22.

Injection yield (%)=Weight after injection/weight before injection×100

Tumbling yield (%)=Weight after tumbling/weight before tumbling×100

Yield of cooking by heating (%)=Weight after cooking by heating/weight before cooking by heating×100

TABLE 22

| | | Control | Control | |
|---|---|---|---|---|
| Type of pickling liquid used | | Example 5 | Example 6 | Example 28 |
| Yield | Injection yield (%) | 110.4 | 108.8 | 111.4 |
| | Tumbling yield (%) | 104.5 | 102.7 | 103.4 |
| | Yield of cooking by | 91.8 | 95.5 | 98.4 |
| | heating (%) | | | |

| | | | |
|---|---|---|---|
| Sensory evaluation | 1 | 2 | 3 |
| (feeling of fatty meat) | | | |

As shown in Table 22, the salmon steak produced by using the pickling liquid of Example 28 for injection had a feeling of fatty meat and a moist texture as compared with the Control Example. Even from the viewpoint of the yield of cooking by heating, the salmon steak produced by using Example 28 gave satisfactory results as compared with the case of using the Control Example.

### Examples 29 and 30

(Preparation of Sauce)

The ingredients described in Table 23 were used according to the formulations of the same table, and sauces were produced by the following procedure.

1. Onions were diced and heated in a 600-W microwave oven for 1 minute. After cooling at normal temperature, the onions were stirred with a blender to form a paste. Only in Example 30, apples were grated and added to the above-mentioned onions.

2. Powdery granular material 1 was added to olive oil and stirred, subsequently the paste obtained by procedure 1. and all the remaining ingredients were added thereto, and the mixture mixed in a tabletop mixer at a medium speed for 5 minutes.

TABLE 23

| | | Example | Example |
|---|---|---|---|
| | | 29 | 30 |
| Formulation | (A1) Powdery granular material 1 | 8.3 | 9.5 |
| (unit: | Dried egg white | 4.2 | |
| parts) | Whole egg | | 19.0 |
| | Olive oil | 41.7 | 38.1 |
| | Soy sauce | | 14.3 |
| | Water | 34.8 | |
| | Onion | 7.0 | 5.7 |
| | Apple | | 5.7 |
| | Anchovy paste | 2.1 | 2.8 |
| | Grated garlic | 0.4 | 0.6 |
| | Sugar | | 1.9 |
| | Salt | 1.4 | 0.4 |
| | White pepper | 0.1 | 0.1 |
| | Ground sesame | | 1.9 |
| | Total | 100.0 | 100.0 |

| | | |
|---|---|---|
| Protein/(A) (% by mass) | 51.0 | 48.1 |
| Total water portion in emulsion (% by mass) | 42.5 | 35.6 |
| Total oil portion in emulsion (% by mass) | 41.9 | 41.3 |
| Oil portion/(A) (mass ratio) | 5.0 | 4.3 |
| ((A) + water + edible oil and fat + | 96.9 | 91.0 |
| emulsifying material)/emulsion (% by mass) | | |

Information on the ingredients used in Table 23 is shown below. The water content, protein content, and lipid content of each ingredient were calculated on the basis of the Standard Tables of Food Composition in Japan, 2020 edition (8th revision).

Dried egg white: Dried Egg White W type, manufactured by Zen-noh Kewpie Egg-Station Co., Ltd. (protein content 86.5% by mass, lipid content 0.4% by mass)

Whole egg (water content 75.0% by mass, protein content 12.2% by mass, lipid content 10.2% by mass)

Olive oil: “FILIPPO BERIO extra virgin olive oil”, manufactured by J-Oil Mills, Inc., solid fat content at 20° C. 0%

Onion (water content 90.1% by mass, protein content 1.0% by mass, lipid content 0.1% by mass)

Apple (water content 84.1% by mass, protein content 0.1% by mass, lipid content 0.2% by mass)

Soy sauce: manufactured by Fujiyu Brewery Co., Ltd. (water content 67.1% by mass, protein content 7.7% by mass, lipid content 0.0% by mass)

Anchovy paste: GIA Anchovy Paste, manufactured by Gia Food, Ltd. (water content 54.3% by mass, protein content 24.2% by mass, lipid content 6.8% by mass)

Ground sesame seeds (water content 1.6% by mass, protein content 20.3% by mass, lipid content 54.2% by mass)

Grated garlic (water content 52.1% by mass, protein content 4.7% by mass, lipid content 0.5% by mass)

From the present example, sauces having an appropriate viscosity and having a smooth external appearance and a texture could be obtained. Furthermore, in Example 29, a sauce in which the flavor of olive oil was felt was obtained. In Example 30, a Japanese-style sauce in which a rich sesame flavor was felt was obtained. These sauces can be used for use applications of seasoning any foods, including sandwiches, salads, fried foods, noodles, and the like.

### Example 31 and Control Example 7

(Production of Marron Cream)

Marron cream was produced by the following procedure by using the ingredients described in Table 24 according to the formulation of the same table.

1. An emulsion to be used for Example 31 was produced. Powdery granular material 1, milk, margarine, and water were mixed, and the mixture was mixed with a beater by using a 5-coat mixer.

2. The ingredients of (1) described in Table 24 were mixed in a bowl, and the mixture was mixed with a rubber spatula until the mixture became smooth. For Example 31, the emulsion produced by procedure 1. Was added thereto, and the mixture was further mixed.

3. The ingredients of (2) were added to the mixture obtained by procedure 2., and the mixture was further mixed with a rubber spatula.

4. The ingredients of (3) were added thereto, and the mixture was further mixed until the mixture became uniform.

TABLE 24

| | | | Control | |
|---|---|---|---|---|
| | | | Example | Example |
| | | | 7 | 31 |
| Formulation | (1) Marron paste | | 58.0 | 40.6 |
| (unit: | (1) White sugar | | 2.9 | 2.9 |
| parts) | (1) Liquid sugar | | 2.9 | 2.9 |
| | (2) Vegetable cream | | 23.2 | 23.2 |
| | (2) Fresh cream | | 11.6 | 11.6 |
| | (3) Flavor | | 0.9 | 0.9 |
| | (3) Caramel | | 0.6 | 0.6 |
| | Emulsion | (A1) Powdery granular | | 4.3 |
| | | material 1 | | |
| | (composition for | Milk | | 6.5 |
| | food) | Margarine | | 4.3 |
| | | Water | | 2.2 |

| | | |
|---|---|---|
| Total | 100 | 100 |

| | | |
|---|---|---|
| Protein/(A) (% by mass) | — | 59.9 |
| Total water portion in emulsion (% by mass) | — | 49.5 |
| Total oil portion in emulsion (% by mass) | — | 22.2 |
| Oil portion/(A) (mass ratio) | — | 0.9 |
| ((A) + water + edible oil and fat + emulsifying | — | 100.0 |
| material)/emulsion (% by mass) | | |

Information on the ingredients used for the emulsion is shown below in Table 24. For the water content, protein content, and lipid content of margarine, the nutrition facts label of the product was referred to, and the water content, protein content, and lipid content of other ingredients were calculated on the basis of the Standard Tables of Food Composition in Japan 2020 edition (8th revision).

Milk: Hokkaido 3.6 milk, manufactured by Takanashi Milk Products Co., Ltd. (water content 87.4% by mass, protein content 3.3% by mass, lipid content 3.6% by mass)

Margarine: “Gran Master Primeran i”, manufactured by J-Oil Mills, Inc. (water content 16.0% by mass, protein content 0.1% by mass, lipid content 83.9% by mass), solid fat content at 20° C. 20.4%

According to Example 31, a marron cream having satisfactory texture and flavor was obtained, in which the melt-in-the mouth feeling was satisfactory as compared with that of Control Example 7, and the flavor spread at the moment when the cream was put in the mouth. The marron cream of the present example can be eaten alone and can also be suitably used as, for example, a material constituting confectionery, desserts, bakery foods, and the like.

### Example 32

(Production of Financier)

The ingredients described in Table 25 were used according to the formulation of the same table, and a financier was produced by the following procedure.

1. An emulsion to be used in each Example was produced. Margarine for emulsion was completely dissolved, powdery granular material 1 was added thereto and mixed, egg white and water were further added thereto, and the mixture was mixed with a beater by using a 5-coat mixer until the mixture became thick.

2. The ingredients of (1) described in Table 25 were introduced into a bowl and mixed, the ingredients of (2) and the ingredients of (3) that had been heated to melt were added thereto, and the mixture was mixed with a rubber spatula until the mixture became smooth.

3. An emulsion obtained by procedure 1. was added to the bowl of procedure 2, and the mixture was mixed until the mixture became uniform.

4. A dough obtained by procedure 3. was filled into a financier mold and baked in an oven at 180° C. for 14 minutes in Example 32, and for 18 minutes in Example 33. After completion, the product was taken out of the oven and cooled at room temperature.

TABLE 25

| | | | Example | Example |
|---|---|---|---|---|
| | | | 32 | 33 |
| Formulation | (1) Weak flour | | 15.2 | 13.7 |
| (unit: | (1) Sugar powder | | 21.7 | 19.5 |
| parts) | (1) Baking powder | | 0.4 | 0.4 |
| | (1) Almond powder | | 4.3 | 3.9 |
| | (2) Egg white | | 13.0 | 11.7 |
| | (3) Margarine | | 17.3 | 17.6 |
| | Emulsion | (A1) Powdery | 4.3 | 3.9 |
| | | granular material 1 | | |
| | (composition for | Egg white | 8.7 | 7.8 |
| | food) | Margarine | 13.0 | 15.6 |
| | | Water | 2.2 | 5.9 |

| | | |
|---|---|---|
| Total | 100 | 100 |

| | | |
|---|---|---|
| Protein/(A) (% by mass) | 21.9 | 22.2 |
| Total water portion in emulsion (% by mass) | 42.3 | 46.0 |
| Total oil portion in emulsion (% by mass) | 38.1 | 38.9 |
| Oil portion/(A) (mass ratio) | 2.5 | 3.3 |
| ((A) + water + edible oil and fat + emulsifying | 100.0 | 100.0 |
| material)/emulsion (% by mass) | | |

Information on the ingredients used for the emulsion is shown below in Table 25. For the water content, protein content, and lipid content of margarine, the nutrition facts label of the product was referred to, and the water content, protein content, and lipid content of other ingredients were calculated on the basis of the Standard Tables of Food Composition in Japan 2020 edition (8th revision).

Egg white (water content 88.4% by mass, protein content 10.5% by mass, lipid content 0% by mass)

Margarine: “Gran Master Eire i”, manufactured by J-Oil Mills, Inc. (water content 16.0% by mass, protein content 0.3% by mass, lipid content 82.60), 21.6% of solid fat content at 20° C.

The financier obtained by the present example was well-baked without oil seeping or the like, irrespective of the fact that the blending amount of oil and fat was large compared with that of common financiers. Furthermore, the product had a soft and juicy texture compared with common financiers.

### Preparation Example 44: Preparation of Emulsion Using Powdery Granular Material 5

The ingredients described in Table 26 were used according to the formulation described in the same table, and an emulsion was produced by the following procedure. In the present example, mixing of the ingredients was performed using a container capable of heating and cooling and a stirrer (Mazela ZZ-1000 type, manufactured by Tokyo Rikakikai Co., Ltd.) under the conditions of 50 rpm to 200 rpm.

1. The ingredients of (1) in Table 26 were mixed with stirring and heated to 50° C. to 60° C., the emulsifier was dissolved, subsequently the ingredients of (2) were added thereto, and the mixture was further mixed.

2. The ingredients of (3) were introduced into the mixture obtained by procedure 1., and then the mixture was mixed with stirring to be emulsified.

3. Sterilization by heating was carried out until the core temperature reached 85° C.

4. Thereafter, the mixture was cooled to 60° C., the ingredients of (4) were introduced into the mixture, and the mixture was mixed with stirring.

5. The mixture was cooled to room temperature, and the external appearance and physical properties were evaluated.

TABLE 26

| | | | Preparation |
|---|---|---|---|
| | | | Example 44 |
| Formulation | (1) | Olive oil | 29.78 |
| (unit: | (1) | Diglycerin monostearic acid ester | 0.36 |
| parts) | (1) | Decaglycerin monomyristate | 1.03 |
| | (2) | Powdery granular material 5 | 13.24 |
| | (3) | Starch syrup | 9.93 |
| | (3) | Water | 39.70 |
| | (4) | Table salt | 5.96 |

| | |
|---|---|
| Total | 100.00 |

(Raw Material Information)

Details of the raw materials described in Table 26 are as follows.

Olive oil: “AJINOMOTO Olive oil”, manufactured by J-Oil Mills, Inc.

Diglycerin monostearic acid ester: “Poem J-2081V”, manufactured by Riken Vitamin Co., Ltd.

Decaglycerin monomyristate: “Sunsoft Q-14S”, manufactured by Taiyo Kagaku Co., Ltd.

Starch syrup: “Hallodex”, manufactured by Hayashibara Co., Ltd.

From the present example, a smooth paste-like emulsion having excellent shelf life characteristics was obtained. The use applications of the obtained emulsion are not limited; and, the emulsion can be suitably used, for example, as a texture improving agent for bread.

### Preparation Example 45

The ingredients described in Table 27 were used according to the formulation described in the same table, and an emulsion was produced.

(Preparation Procedure)

Powdery granular material 1 and skim milk powder were added to soybean oil and mixed, and the mixture was further mixed with stirring while water was further added thereto.

TABLE 27

| | | Preparation |
|---|---|---|
| | | Example 45 |
| Formulation | (A1) Powdery granular material 1 | 50.0 |
| (unit: g) | Skim milk powder | 15.0 |
| | Soybean oil | 200.0 |
| | Water | 125.0 |

| | |
|---|---|
| Protein/(A) (% by mass) | 0.1 |
| Total water portion in emulsion (% by mass) | 32.1 |
| Total oil portion in emulsion (% by mass) | 51.3 |
| Oil portion/(A) (mass ratio) | 4.00 |
| ( (A) + water + edible oil and fat + emulsifying | 100.0 |
| material)/emulsion (% by mass) | |
| Properties of emulsion | Pasty |

Details of the ingredients of Table 27 are described below.

Soybean oil: “AJINOMOTO soybean salad oil” (manufactured by J-Oil Mills, Inc.)

Skim milk powder: Skim milk powder, manufactured by Hokkaido Dairy Products Co., Ltd. (protein content 34. 0% by mass, lipid content 1.0% by mass)

From the present example, a paste-like emulsion was obtained. The use applications of the obtained emulsion are not limited; and, the emulsion can be suitably used, for example, as a texture improving agent for meat processed foods and bread.

This application claims priority from Japanese Patent Application No. 2020-097232, filed Jun. 3, 2020; Japanese Patent Application No. 2020-192077, filed Nov. 18, 2020; and Japanese Patent Application No. 2021-012471, filed Jan. 28, 2021, the disclosures of which are incorporated herein by reference in their entirety.

1. A method for producing a composition for food including a component (A), water, edible oil and fat, and an emulsifying material, the method comprising:
a step of obtaining an emulsion by mixing the component (A), the water, the edible oil and fat, and the emulsifying material,
wherein the emulsifying material is at least one kind selected from the group consisting of an emulsifier, a protein, and an oil and fat-processed starch,
a content of oil and fat in the emulsion is equal to or more than 0.1 and equal to or less than 120 in terms of mass ratio with respect to the component (A), and
a total amount of the component (A), the water, the edible oil and fat, and the emulsifying material in the emulsion is equal to or more than 50% by mass and equal to or less than 100% by mass with respect to the entirety of the emulsion,
component (A): one kind or two kinds selected from the group consisting of component (A1) and component (A2):
component (A1): a powdery granular material satisfying the following conditions (1) to (4):
(1) a starch content is equal to or more than 75% by mass,
(2) a low molecular weight starch obtained from a starch having an amylose content of equal to or more than 5% by mass is included at a proportion of equal to or more than 3% by mass and equal to or less than 45% by mass, and the low molecular weight starch has a peak molecular weight of equal to or more than 3×10³ and equal to or less than 5×10⁴,
(3) a degree of swelling in cold water at 25° C. is equal to or higher than 5 and equal to or lower than 20, and
(4) a content of a fraction passing through a sieve with a mesh size of 3.35 mm and remaining on a sieve with a mesh size of 0.038 mm is equal to or more than 60% by mass and equal to or less than 100% by mass; and
component (A2): pregelatinized starch.

2. The method for producing a composition for food according to claim 1,
wherein a total content of moisture in the emulsion is more than 2 in terms of mass ratio with respect to the component (A).

3. The method for producing a composition for food according to claim 1,
wherein the edible oil and fat is one kind or two or more kinds selected from the group consisting of rapeseed oil, olive oil, lard, and milk fat.

4. The method for producing a composition for food according to claim 1,
wherein the edible oil and fat is one kind or two or more kinds selected from the group consisting of rapeseed oil, olive oil, lard, milk fat, and soybean oil.

5. The method for producing a composition for food according to claim 1,
wherein the protein is one kind or two or more kinds selected from the group consisting of soybean protein, pea protein, milk protein, and egg protein.

6. The method for producing a composition for food according to claim 1,
wherein the emulsifying material or a formulation component including the emulsifying material is one kind or two or more kinds selected from the group consisting of soybean milk, milk, fresh cream, skim milk powder, whole milk powder, casein, egg yolk, egg white, and whole egg.

7. The method for producing a composition for food according to claim 1,
wherein the step of obtaining an emulsion is a step of obtaining the emulsion, in which a heating yield of a dough obtained by heating the emulsion at 200° C. for 5 minutes is equal to or greater than 85% by mass and equal to or less than 100% by mass.

8. The method for producing a composition for food according to claim 1,
wherein a solid fat content at 20° C. of the edible oil and fat is equal to or less than 40%.

9. The method for producing a composition for food according to claim 1,
further comprising, after the step of obtaining an emulsion, a step of performing a pressurized heating treatment.

10. The method for producing a composition for food according to claim 1,
further comprising, after the step of obtaining an emulsion, one kind or two kinds of steps selected from the group consisting of frozen storage and refrigerated storage.

11. A method for producing a food, the method comprising:
a step of obtaining a composition for food by the method for producing a composition for food according to claim 1; and
a step of obtaining a food by preparing ingredients including the composition for food.

12. The method for producing a food according to claim 11, wherein the step of obtaining a food includes cooking by heating.

13. A method for enhancing workability when mixing raw materials including component (A), water, edible oil and fat, and an emulsifying material to produce a dough for a bakery food, the method comprising:
a step of obtaining an emulsion by mixing the component (A), the water, the edible oil and fat, and the emulsifying material,
wherein the emulsifying material is at least one kind selected from the group consisting of an emulsifier, a protein, and an oil and fat-processed starch,
a content of oil and fat in the emulsion is equal to or more than 0.1 and equal to or less than 120 in terms of mass ratio with respect to the component (A), and
a total amount of the component (A), the water, the edible oil and fat, and the emulsifying material in the emulsion is equal to or more than 50% by mass and equal to or less than 100% by mass with respect to the entirety of the emulsion,
component (A): one kind or two kinds selected from the group consisting of component (A1) and component (A2):
component (A1): a powdery granular material satisfying the following conditions (1) to (4):
(1) a starch content is equal to or more than 75% by mass,
(2) a low molecular weight starch obtained from a starch having an amylose content of equal to or more than 5% by mass is included, a content of the low molecular weight starch being equal to or more than 3% by mass and equal to or less than 45% by mass, and the low molecular weight starch has a peak molecular weight of equal to or more than 3×10³ and equal to or less than 5×10⁴,
(3) a degree of swelling in cold water at 25° C. is equal to or higher than 5 and equal to or lower than 20, and
(4) a content of a fraction passing through a sieve with a mesh size of 3.35 mm and remaining on a sieve with a mesh size of 0.038 mm is equal to or more than 60% by mass and equal to or less than 100% by mass; and
component (A2): pregelatinized starch.

14. A method for enhancing a texture of a meat processed food or a meat-like processed food, both including raw materials including component (A), water, edible oil and fat, and an emulsifying material, the method comprising:
a step of obtaining an emulsion by mixing the component (A), the water, the edible oil and fat, and the emulsifying material,
wherein the emulsifying material is at least one kind selected from the group consisting of an emulsifier, a protein, and an oil and fat-processed starch,
a content of oil and fat in the emulsion is equal to or more than 0.1 and equal to or less than 120 in terms of mass ratio with respect to the component (A), and
a total amount of the component (A), the water, the edible oil and fat, and the emulsifying material in the emulsion is equal to or more than 50% by mass and equal to or less than 100% by mass with respect to the entirety of the emulsion,
component (A): one kind or two kinds selected from the group consisting of component (A1) and component (A2):
component (A1): a powdery granular material satisfying the following conditions (1) to (4):
(1) a starch content is equal to or more than 75% by mass,
(2) a low molecular weight starch obtained from a starch having an amylose content of equal to or more than 5% by mass is included, a content of the low molecular weight starch being equal to or more than 3% by mass and equal to or less than 45% by mass, and the low molecular weight starch has a peak molecular weight of equal to or more than 3×10³ and equal to or less than 5×10⁴,
(3) a degree of swelling in cold water at 25° C. is equal to or higher than 5 and equal to or lower than 20, and
(4) a content of a fraction passing through a sieve with a mesh size of 3.35 mm and remaining on a sieve with a mesh size of 0.038 mm is equal to or more than 60% by mass and equal to or less than 100% by mass; and
component (A2): pregelatinized starch.

15. A method for enhancing a texture after storage of a food including raw materials including component (A), water, edible oil and fat, and an emulsifying material, the method comprising:
a step of obtaining an emulsion by mixing the component (A), the water, the edible oil and fat, and the emulsifying material,
wherein the emulsifying material is at least one kind selected from the group consisting of an emulsifier, a protein, and an oil and fat-processed starch,
a content of oil and fat in the emulsion is equal to or more than 0.1 and equal to or less than 120 in terms of mass ratio with respect to the component (A), and
a total amount of the component (A), the water, the edible oil and fat, and the emulsifying material in the emulsion is equal to or more than 50% by mass and equal to or less than 100% by mass with respect to the entirety of the emulsion,
component (A): one kind or two kinds selected from the group consisting of component (A1) and component (A2):
component (A1): a powdery granular material satisfying the following conditions (1) to (4):
(1) a starch content is equal to or more than 75% by mass,
(2) a low molecular weight starch obtained from a starch having an amylose content of equal to or more than 5% by mass is included, a content of the low molecular weight starch being equal to or more than 3% by mass and equal to or less than 45% by mass, and the low molecular weight starch has a peak molecular weight of equal to or more than 3×10³ and equal to or less than 5×10⁴,
(3) a degree of swelling in cold water at 25° C. is equal to or higher than 5 and equal to or lower than 20, and
(4) a content of a fraction passing through a sieve with a mesh size of 3.35 mm and remaining on a sieve with a mesh size of 0.038 mm is equal to or more than 60% by mass and equal to or less than 100% by mass; and
component (A2): pregelatinized starch.
